(19) United States
(12) Patent Application Publication
(10) Pub. No.: US 2010/0302802 A1
(43) Pub. Date: Dec. 2, 2010

(54) ILLUMINATION DEVICES

(75) Inventors: Ion Bita, San Jose, CA (US); Gang Xu, Cupertino, CA (US); Russell Wayne Gruhlke, San Jose, CA (US); Kollengode S. Narayanan, San Jose, CA (US)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Tecnologies, Inc., San Diego, CA (US)

(21) Appl. No.: 12/789,397

(22) Filed: May 27, 2010

Related U.S. Application Data
(60) Provisional application No. 61/182,665, filed on May 29, 2009.

(51) Int. Cl. F21V 7/22; F21V 21/28

(52) U.S. Cl. 362/606; 362/611; 362/419

(57) ABSTRACT

Illumination device and methods of making the same are disclosed. In one embodiment, an illumination device includes a light source, a light guide having a first planar surface, a first end and a second end, and a length therebetween, the light guide positioned to receive light from the light source into the light guide first end, and the light guide configured such that light from the light source provided into the first end of the light guide propagates towards the second end, a plurality of light turning features that are configured to reflect light propagating towards the second end of the light guide out of the planar first surface, and one or more light redirection features configured to redirect light within the light guide at more useful angles.

### CROSS-REFERENCE TO RELATED APPLICATIONS

This application claims the benefit of U.S. Provisional Application No. 61/182,665 filed on May 29, 2009, titled “ILLUMINATION DEVICES,” which is hereby expressly incorporated by reference in its entirety.

### BACKGROUND

1. Field

The field of the invention relates to electromechanical systems and illumination devices thereof.

2. Description of the Related Art

Electromechanical systems include devices having electrical and mechanical elements, actuators, transducers, sensors, optical components (e.g., mirrors), and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers or that add layers to form electrical and electromechanical devices. One type of electromechanical systems device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments,” one will understand how the features of this invention provide advantages over other display devices.

Various embodiments described herein comprise an illumination device including a light guide layer with light turning features and light redirection features formed therein.

In one embodiment, an illumination device comprises a light source, a light guiding having a first surface, a second surface disposed opposite to the first surface, a first end, a second end, and a length between the first end and the second end, the light guide positioned to receive light from the light source into the light guide first end, and the light guide configured such that light from the light source provided into the first end of the light guide propagates towards the second end, a plurality of light turning features, each light turning feature having at least one turning section aligned to turn light propagating toward the second end of the light guide out of the light guide, and at least one light redirection feature having at least one redirection section aligned to redirect light incident thereon within the light guide along one or more directions.

Other aspects can be included in the embodiments described herein. For example, the light guide can be disposed with respect to a reflective display such that light turned out of the light guide illuminates the reflective display. In some embodiments, the reflective display can comprise a light modulating array. In some embodiments, the device can comprise a processor that is configured to communicate with the light modulating array, the processor being configured to process image data, and a memory device that is configured to communicate with the processor. The display device can comprise a driver circuit configured to send at least one signal to the light modulating array. The display device can comprise a controller configured to send at least a portion of the image data to the driver circuit. In some embodiments, the device comprises an image source module configured to send image data to the processor. The image source module can comprise at least one of a receiver, transceiver, and transmitter. In some embodiments, the device comprises an input device configured to receive input data and to communicate said input data to said processor.

In some embodiments, at least one light turning feature is disposed on the first surface of the light guide and configured to turn light out of the second surface of the light guide and at least one light turning feature can be disposed on the second surface and configured to turn light out of the first surface of the light guide. In some embodiments, at least one light redirection feature is disposed on the first surface and/or second surface of the light guide. Some embodiments of the turning features comprise elongated grooves. In some embodiments, the light redirection feature is cone-shaped and a redirection section of the cone and the first surface or second surface of the light guide form an obtuse angle that is between about 170 degrees and about 179.5 degrees. In some embodiments, the light redirection feature is in the shape of a frustum of a cone and a redirection section of the frustum and the first surface or second surface of the light guide form an obtuse angle that is between about 170 degrees and about 179.5 degrees. In some embodiments, the light redirection feature is pyramid-shaped and a redirection section of the pyramid and the first surface or second surface of the light guide form an obtuse angle that is between about 170 degrees and about 179 degrees. In some embodiments, the light redirection feature is in the shape of a frustum of a pyramid and a redirection section of the frustum and the first surface or second surface of the light guide form an obtuse angle that is between about 170 degrees and about 179 degrees. In some embodiments, the light redirection feature redirects light via reflection. In some embodiments, the light redirection feature redirects light via refraction.

Some embodiments of the device comprise a plurality of light redirection features. In some embodiments, light redirection features are disposed in a uniform pattern throughout the light guide. In some embodiments, light redirection features are disposed in a non-uniform pattern throughout the light guide. In some embodiments, at least one of the light redirection features varies from at least one other light redirection feature in at least one of size or shape. The light redirection features can be configured to redirect light in-plane. In some embodiments, the light redirection features are configured to redirect light on a plane disposed generally parallel to the first surface. The light redirection features can be configured to redirect light out-of-plane. In some embodiments, the light redirection features are configured to redirect light on a plane disposed generally normal to the first surface. The light redirection features can be configured to redirect light out-of-plane and in-plane.

In one embodiment, an illumination device comprises a light source, a light guiding having a first surface, a second surface disposed opposite to the first surface, a first end, a second end, and a length between the first end and the second end, the light guide positioned to receive light from the light source into the light guide first end, and the light guide configured such that light from the light source provided into the first end of the light guide propagates towards the second end, a plurality of light turning features, each light turning feature having at least one turning section aligned to turn light propagating toward the second end of the light guide out of the light guide, and a light redirection layer disposed on at least a portion of the second surface of the light guide. The light redirection layer can be configured to reflect light incident thereon within the light guide along one or more directions. In some embodiments, the light redirection layer comprises a diffractive layer. The light redirection layer can comprise a volume diffractive element. In some embodiments, the diffractive layer comprises a low haze diffuser. In some embodiments, at least one light turning feature is disposed on the first surface of the light guide and configured to turn light out of the second surface of the light guide. In some embodiments, at least one light turning feature is disposed on the second surface of the light guide and configured to turn light out of the first surface of the light guide.

In another embodiment, an illumination device comprises a light source, a light guiding having a first surface, a second surface disposed opposite to the first surface, a first end, a second end, and a length between the first end and the second end, the light guide positioned to receive light from the light source into the light guide first end, and the light guide configured such that light from the light source provided into the first end of the light guide propagates towards the second end, a plurality of light turning features, each light turning feature having at least one turning section aligned to turn light propagating toward the second end of the light guide out of the light guide, and at least one structure embedded at least partially in the light guide, the at least one structure comprising a material with an index of refraction characteristic that is different than the index of refraction characteristic of the light guide.

In some embodiments, the structure comprises air at least partially enclosed by one or more surfaces. In some embodiments, the device comprises a plurality of structures. In some embodiments, at least one structure varies from at least one other structure in one of size or shape. The structure can comprise a prism having a triangular cross-section. In some embodiments, the structure is completely embedded within the light guide. In some embodiments, the structure is configured to redirect light in-plane. The structure can redirect light on a plane disposed generally parallel to the first surface. In some embodiments, the structure is configured to redirect light out-of-plane. The structure can redirect light on a plane disposed generally normal to the first surface. In some embodiments, the structure is configured to redirect light in-plane and out-of-plane.

In one embodiment, an illumination device comprises means for providing light, means for guiding light having a first surface, a second surface disposed opposite to the first surface, a first end and a second end, and a length therebetween, the means for guiding light being positioned to receive light from the light source into the means for guiding light first end, and the means for guiding light configured such that light from the means for providing light provided into the first end of the means for guiding light propagates towards the second end, a plurality of means for turning light configured to turn light propagating toward the second end of the light guiding means out of the means for guiding light, and a means for redirecting light configured to redirect light incident thereon within the means for guiding light along one or more directions. In some embodiments, the means for providing light comprises a light emitting diode. The means for providing light can comprise a light bar. In some embodiments, the means for guiding light comprises a light guide. The means for redirecting light can comprise one or more frustum-shapes indentations in the means for turning light. The means for redirecting light can comprise a diffractive layer disposed parallel to at least a portion of the means for guiding light. In some embodiments, the means for redirecting light comprises a structure embedded at least partially in the means for guiding light, the structure comprising a material with an index of refraction characteristic that is different than an index of refraction characteristic of the means for guiding light.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross-section of the device of FIG. 1.

FIG. 7B is a cross-section of an alternative embodiment of an interferometric modulator.

FIG. 7C is a cross-section of another alternative embodiment of an interferometric modulator.

FIG. 7D is a cross-section of yet another alternative embodiment of an interferometric modulator.

FIG. 7E is a cross-section of an additional alternative embodiment of an interferometric modulator.

FIG. 8 is a cross-section of one embodiment of a display device having a light source, a light guide, and a reflective display.

FIG. 9A is a perspective view of one embodiment of an illumination device having a light source and a light guide with turning features formed thereon.

FIG. 9B is a perspective view of one embodiment of an illumination device having a light source and a light guide with turning features formed thereon.

FIG. 9C is a perspective view of one embodiment of an illumination device having a light source and a light guide with turning film formed thereon.

FIG. 9D is a perspective view of one embodiment of an illumination device having a light source and a light guide with turning features formed thereon.

FIG. 10A is a top plan view of one embodiment of an illumination device having a light source and a light guide with turning features formed thereon.

FIG. 10B is a top plan view of one embodiment of an illumination device having a light source and a light guide with turning features formed thereon.

FIG. 10C is a top plan view of one embodiment of an illumination device having a light source and a light guide with turning features formed thereon.

FIG. 10D is a top plan view of one embodiment of an illumination device having a light source and a light guide with turning features formed thereon.

FIG. 10E is a top plan view of one embodiment of an illumination device having a light source and a light guide with turning features formed thereon.

FIG. 10F is a top plan view of one embodiment of an illumination device having a light source and a light guide with turning features formed thereon.

FIG. 10G is a top plan view of one embodiment of an illumination device having a light source and a light guide with turning features formed thereon.

FIG. 10H is a top plan view of one embodiment of an illumination device having a light source and a light guide with turning features formed thereon.

FIG. 11A is a top plan view of one embodiment of a light source emitting a lobe of light.

FIG. 11B is a top plan view of one embodiment of a light source emitting a lobe of light.

FIG. 11C is a top plan view of one embodiment of a light source emitting a lobe of light.

FIG. 11D is a top plan view of one embodiment of a light source emitting a lobe of light.

FIG. 11E is a top plan view of one embodiment of a light source emitting a lobe of light.

FIG. 12A is a top plan view of one embodiment of an illumination device having a light source and a light guide with turning features formed thereon.

FIG. 12B is a top plan view of one embodiment of an illumination device having a light source and a light guide with turning features formed thereon.

FIG. 12C is a top plan view of an illumination device having a light guide illustrating one embodiment of a pattern of turning features and/or redirection features that may be formed on the light guide or on a film disposed on the light guide.

FIG. 13A is a side view of one embodiment of a light source emitting a lobe of light.

FIG. 13B is a side view of one embodiment of a light source emitting a lobe of light.

FIG. 13C is a side view of one embodiment of a light source emitting a lobe of light.

FIG. 13D is a side view of one embodiment of a light source emitting a lobe of light.

FIG. 13E is a side view of one embodiment of a light source emitting a lobe of light.

FIG. 14A is a perspective view of one embodiment of an illumination device having a light guide with turning features and light redirection features.

FIG. 14B is a side view of the illumination device shown in FIG. 14A.

FIG. 14C shows a cross-section of one embodiment of a light redirection feature.

FIG. 14D shows a perspective view of one embodiment of a light redirection feature.

FIG. 14E shows a perspective view of one embodiment of a light redirection feature.

FIG. 15 is a top plan view of one embodiment of an illumination device having a light guide with a light redirection feature.

FIG. 16A is a top plan view of one embodiment of an illumination device having a light source and a light guide with light turning features and light redirection features.

FIG. 16B is a top plan view of one embodiment of an illumination device having a light source and a light guide with light turning features and light redirection features.

FIG. 16C is a top plan view of one embodiment of a light guide with light turning features and light redirection features.

FIG. 17 is a top plan view of one embodiment of an illumination device including a diffuser layer disposed between a light source and a light guide.

FIG. 18A is a perspective view of one embodiment of an illumination device having a light source and a light guide with a light redirection feature.

FIG. 18B is a top plan view of the illumination device shown in FIG. 18A.

FIG. 19A is a top plan view of one embodiment of an illumination device having a light source and a light guide with a light redirection feature.

FIG. 19B is a cross-sectional view of the illumination device shown in FIG. 19A taken along line 19B-19B.

FIG. 20 is a top plan view of one embodiment of an illumination device having a light guide with a light redirection feature.

FIG. 21 is a top plan view of one embodiment of an illumination device having a light guide with a light redirection feature.

FIG. 22 is a top plan view of one embodiment of an illumination device having a light guide with light turning features and varying light redirection features.

FIG. 23A is a perspective view of one embodiment of an illumination device having a light guide disposed over a light diffusion layer.

FIG. 23B is a side view of the illumination device shown in FIG. 23A.

FIG. 23C is a top plan view of the illumination device shown in FIG. 23A.

### DETAILED DESCRIPTION OF CERTAIN EMBODIMENTS

The following detailed description is directed to certain specific embodiments. However, the teachings herein can be applied in a multitude of different ways. In this description, reference is made to the drawings wherein like parts are designated with like numerals throughout. The embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

Illumination devices can be used to provide light for reflective displays when ambient light is insufficient. In some embodiments, an illumination device comprises a light source and a light guide that receives light from the light source. Often the light source may be positioned or offset relative to the display, and in such a position it may not provide sufficient or uniform light directly to the reflective display. Accordingly, an illumination device can also include light turning features that turn light from the light source toward the display, and such turning features can be included in the light guide. In some embodiments, turning features may turn light beams incident on the turning features within a certain angular range and may be unable to turn light beams incident on the turning features that are not within the angular range. The light source may emit beams of light into the light guide at angles outside the angular range that the turning features can turn and thus, some of the light emitted from the light source may be “lost.” Accordingly, in some embodiments, the light guide may include one or more light redirection features that redirect light incident thereon within the light guide such that the redirected light propagates at more useful angles. In some embodiments, the light redirection features may be configured to redirect light travelling on a plane in a new direction on the same plane and/or in a direction that is not on the same plane. In some embodiments, the light redirection features may comprise cones, frustums of cones, pyramids, frustums of pyramids, or prismatic features. In some embodiments, a light redirection layer may be disposed between the light guide and the display and may comprise a diffuser. Light redirection features may comprise materials having different indices of refraction than the light guide that are embedded within the light guide. Turning features and/or light redirection features can be formed on a light guide or a film connected to the light guide. Illumination devices may include one or more turning features and/or one or more light redirection features.

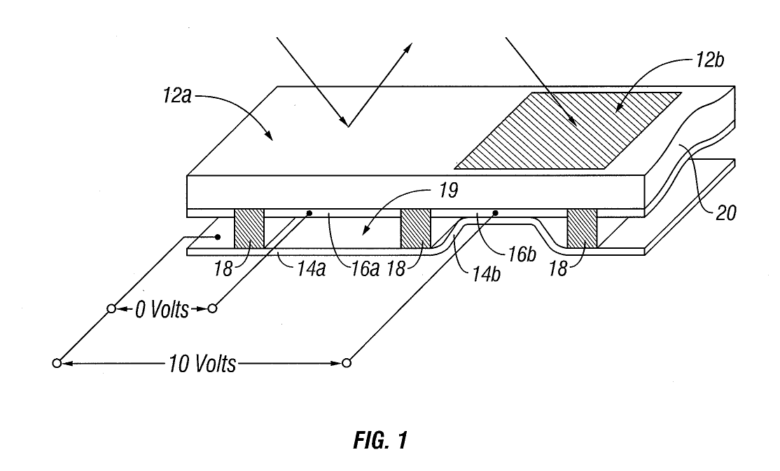

One interferometric modulator display embodiment comprising an interferometric MEMS display element is illustrated in FIG. 1. In these devices, the pixels are in either a bright or dark state. In the bright (“relaxed” or “open”) state, the display element reflects a large portion of incident visible light to a user. When in the dark (“actuated” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical gap with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be between about 10 and 100 um, while the gap 19 may be less than about 1000 Angstroms.

With no applied voltage, the gap 19 remains between the movable reflective layer 14a and optical stack 16a, with the movable reflective layer 14a in a mechanically relaxed state, as illustrated by the pixel 12a in FIG. 1. However, when a potential (voltage) difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by actuated pixel 12b on the right in FIG. 1. The behavior is the same regardless of the polarity of the applied potential difference.

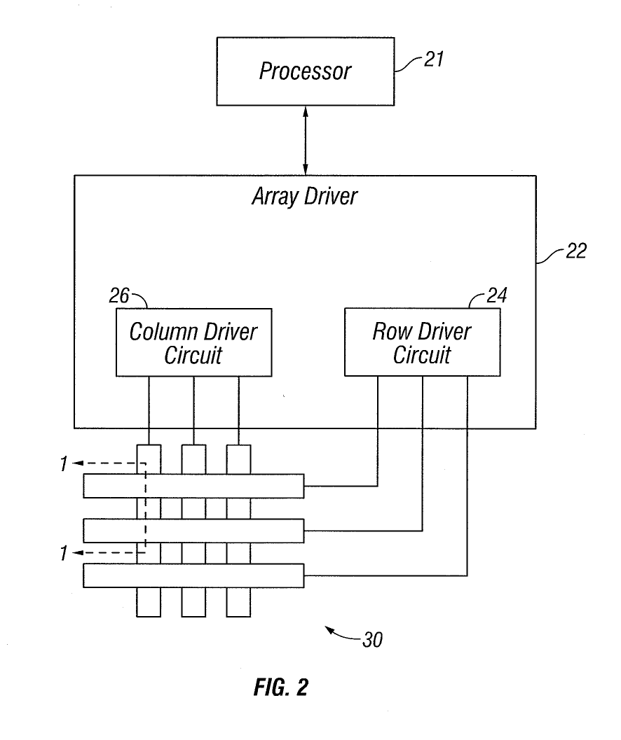

FIGS. 2 through 5 illustrate one exemplary process and system for using an array of interferometric modulators in a display application.

FIG. 2 is a system block diagram illustrating one embodiment of an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross-section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulators, and may have a different number of interferometric modulators in rows than in columns (e.g., 300 pixels per row by 190 pixels per column).

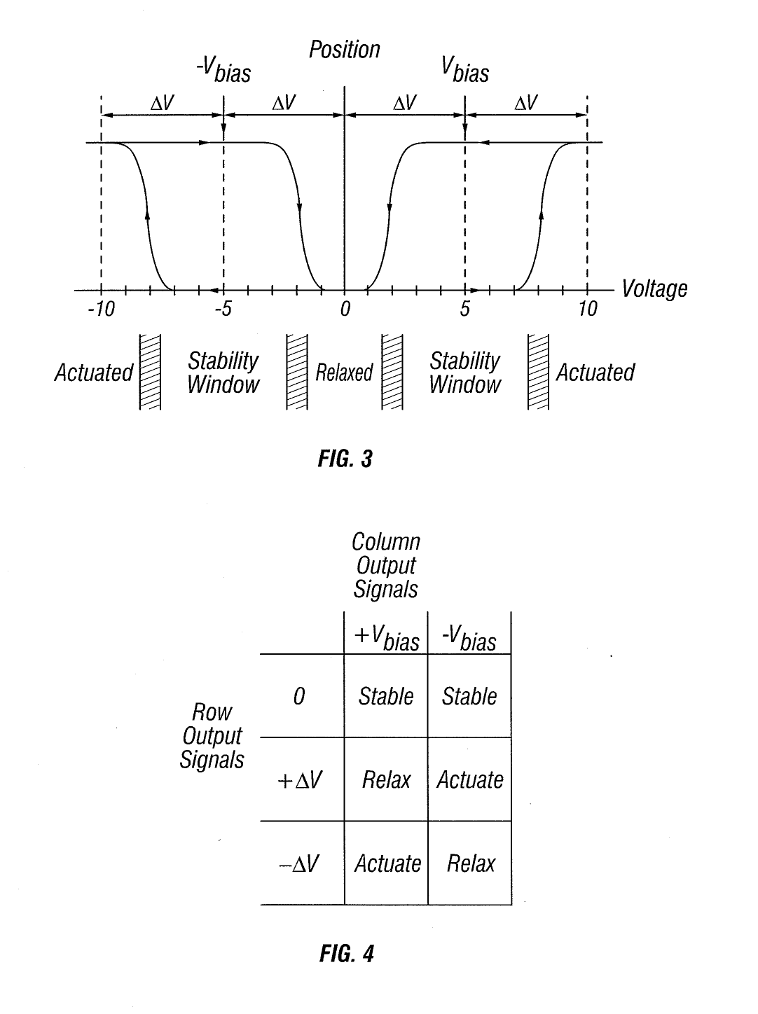

FIG. 3 is a diagram of movable mirror position versus applied voltage for one exemplary embodiment of an interferometric modulator of FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

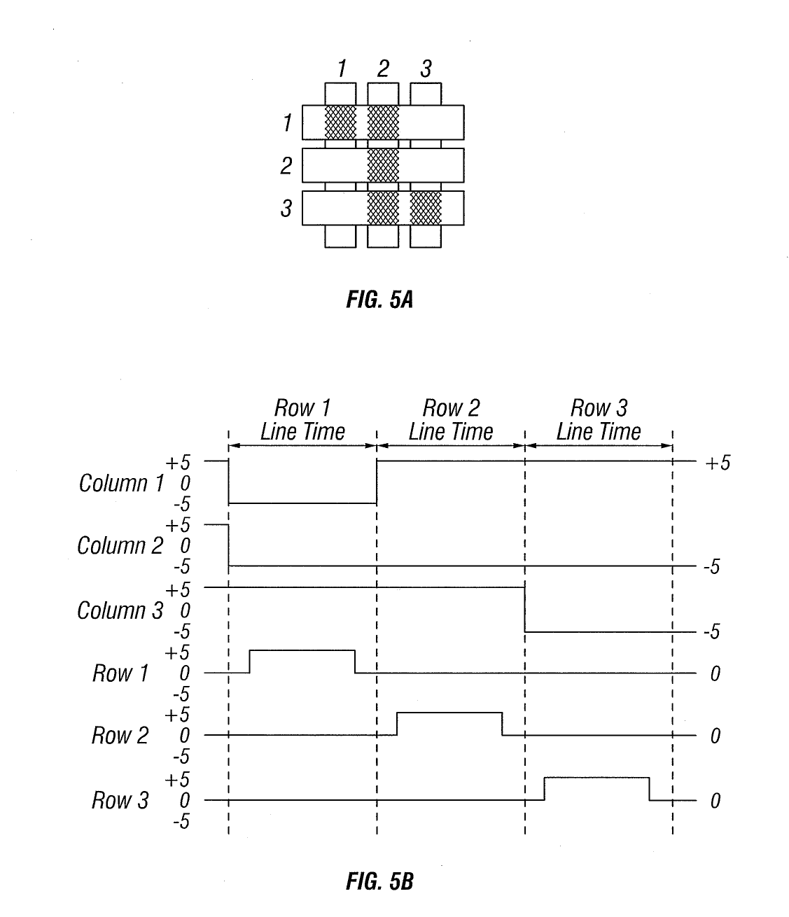

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. The timing, sequence, and levels of voltages used to perform row and column actuation can be varied widely within the general principles outlined above, and the above example is exemplary only, and any actuation voltage method can be used with the systems and methods described herein.

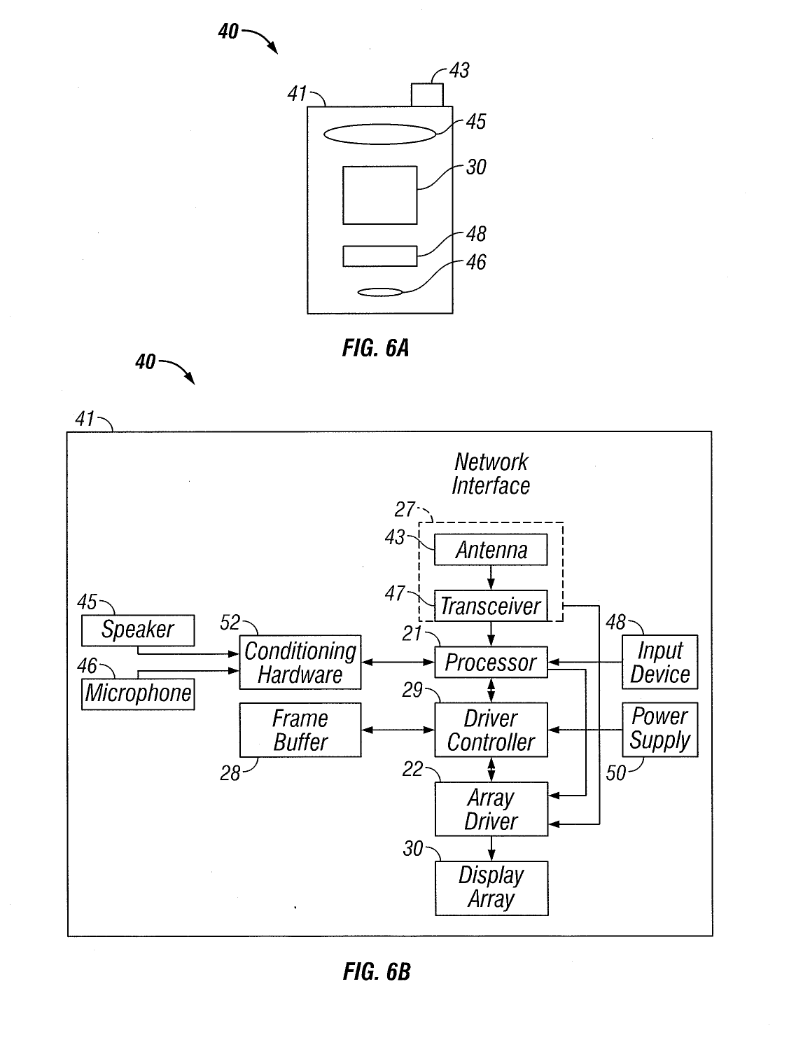

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device,. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. The above-described optimization may be implemented in any number of hardware and/or software components and in various configurations.

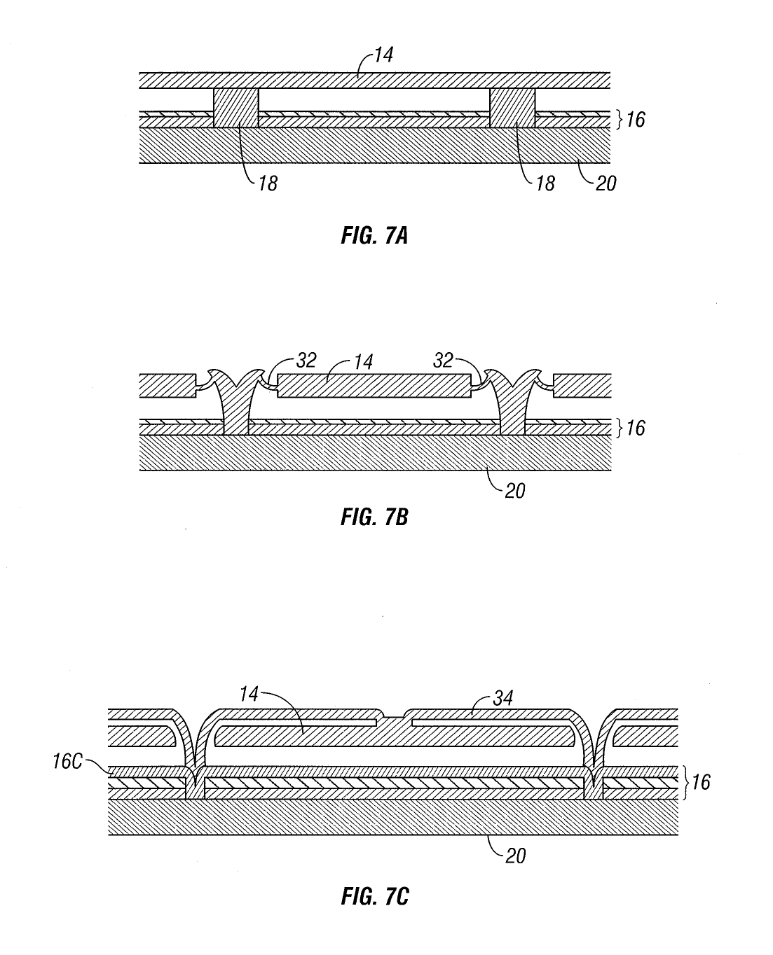

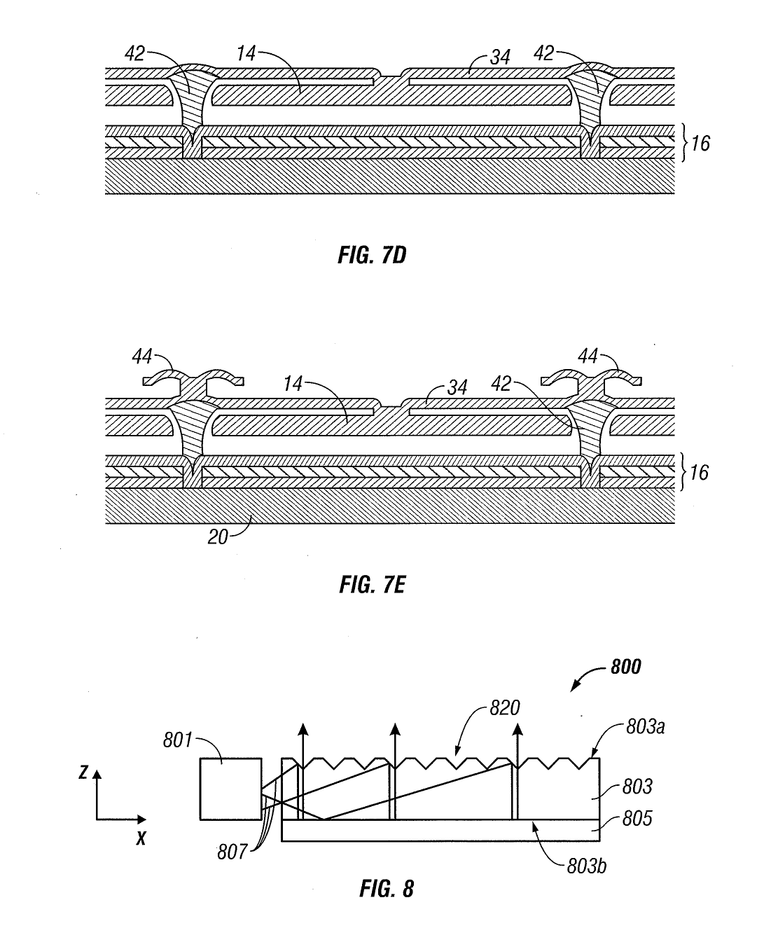

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross-section of the embodiment of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

Interferometric modulators are reflective display elements that can use ambient lighting in daylight or well-lit environments. When ambient light may not be sufficient, a light source can provide the required illumination, either directly or through a light guide that provides a propagation path from the light source to the display elements. In some embodiments, an illumination device provides light to the display elements. The illumination device can include a light source and a light guide. The light guide can be a planar optical device disposed over and in parallel to the display such that incident light passes through the light guide to the display, and light reflected from the display also passes through the light guide. In certain embodiments, the light source includes an optical device (for example, a light bar) that is configured to receive light from a point source (e.g., a light emitting diode) and provides light as a line source. Light entering the light bar may propagate along some or all of the length of the bar and exit out of a surface or edge of the light bar over a portion, or all, of the length of the light bar. Light exiting the light bar may enter an edge of a light guide and then propagate within the light guide such that a portion of the light propagates in a direction across at least a portion of the display at a low-graze angle relative to the surface of the light guide aligned with the display such that light is reflected within the light guide by total internal reflection (“TIR”).

In various embodiments, turning features in the light guide direct light towards the display elements at an angle sufficient so that at least some of the light passes through the light guide to the reflective display. The turning features may turn light beams incident thereon within a certain angular range and may be unable to turn light beams incident thereon that are not within the angular range. Thus, in some embodiments, light emitted from the light source may not be turned toward a reflective display and may be “lost.” Lost light may decrease the overall efficiency of the display device and the overall brightness. Additionally, lost light may result in non-uniform light extraction across the display device. In any of the embodiments described herein, the light guide may also have one or more light redirection features that redirect light incident thereon within the light guide such that the redirected light propagates at more useful angles. The light redirection features may be configured to redirect light beams travelling on a plane in a new direction on the same plane and/or in a direction that is not on the same plane. Therefore, in some embodiments, light redirection features may decrease the amount of light lost and increase the overall efficiency and brightness of a display device.

FIG. 8 illustrates a cross-sectional view of one embodiment of a display device 800 that includes an illumination device configured to provide front light illumination to a reflective display 805. The display device 800 includes a light guide 803 shown in FIG. 8 as having a first surface 803a and a second surface 803b opposite the first surface 803a. In one embodiment, a reflective display 805 may be disposed underneath the second surface 803b of the light guide 803. A light source 801 may be disposed near the light guide 803 and configured to input light into at least one edge or surface of the light guide 803, illustrated in FIG. 8. The light source 801 may comprise any suitable light source, for example, an incandescent bulb, a light bar, a light emitting diode (“LED”), a fluorescent lamp, an LED light bar, an array of LEDs, and/or another light source.

In some embodiments, the reflective display 805 comprises a plurality of reflective elements, for example, interferometric modulators, MEMS devices, reflective spatial light modulators, electromechanical devices, liquid crystal structures, and/or any other suitable reflective display. The reflective elements may be configured in an array. In some embodiments, the reflective display 805 includes a first planar side that is configured to modulate light incident thereon and a second planar side disposed opposite to the first planar side. The size of the reflective display 805 can vary depending upon the application. For example, in some embodiments, the reflective display 805 is sized to fit within a watch or a notebook computer casing. In other embodiments, the reflective display 805 is sized to fit within a mobile phone or similar mobile device.

The light guide 803 may comprise any substantially optically transmissive material that allows light to propagate along a length thereof. For example, the light guide 803 may comprise acrylics, acrylate copolymers, UV-curable resins, polycarbonates, cycloolefin polymers, polymers, organic materials, inorganic materials, silicates, alumina, sapphire, glasses, polyethylene terephthalate (“PET”), PET-G, silicon oxy-nitride, and/or other optically transparent materials. In some embodiments, the light guide 803 comprises multiple layers (not shown). In one embodiment, the light guide 803 has an index of refraction of about 1.52. According to other embodiments, the index of refraction of the light guide can range from about 1.40 to about 2.05.

In certain embodiments, the light guide 803 is a uniform piece of material, or a single layer. In other embodiments the light guide 803 comprises one or more layers. Another material (for example, a turning film or a turning layer) may be disposed on the light guide and may contain any of the turning features or redirection features described herein that are described in relation to a light guide. The light guide 803 may have various thicknesses and other dimensions. For example, in one embodiment, the light guide 803 has a thickness of between about 40 and about 1000 microns. In one embodiment, the light guide 803 has a thickness of about 100 microns. Uniformity of brightness across the display device 800 and efficiency of the display device may be affected by the thickness of the light guide 803. An illumination efficiency of a display device may be determined by comparing the amount of light provided by the light source 801 with the amount of light reflected off of the reflective display 805, and the illumination efficiency may associated with the brightness of a display device 800.

The light guide 803 may include one or more turning features 820 disposed on or along the first side 803a of the light guide. The turning features depicted throughout the attached figures are schematic and exaggerated in size and spacing therebetween for clarity of illustration. The turning features 820 can be configured to receive light propagating along the length of the light guide 803 and turn the light through a large angle, for example, between about 70° and about 90°. The turning features 820 can be configured to include light turning sections (e.g., facets, sidewalls, and/or angled or curved surfaces) that reflect light towards the reflective display 805 at near normal incidence or close thereto. The turning features 820 may be molded, etched, or machined into the light guide 803. In some embodiments, the turning features 820 may comprise a plurality of surface features or volume features. In some embodiments, the turning features 820 comprise diffractive optical elements, and/or grooves, depressions, or pits having one or more turning sections configured to receive and turn light. In certain embodiments, the turning features 820 comprise holograms or holographic features. The holograms may comprise holographic volume or surface features. The size, shape, quantity, and pattern of the turning features 820 may vary.

Still referring to FIG. 8, in one embodiment, light 807 emitted from the light source 801 enters the light guide 803 along one or more edges or surfaces. A portion of light 807 propagates within the light guide 803 at shallow angles (e.g., not near-perpendicular to the reflective display 805) and may generally remain within the light guide 803. When light 807 impinges on turning features 820, it may be turned at a perpendicular or near-perpendicular angle toward the display 805 such that the light 807 is not subject to TIR within the light guide and the light illuminates the display 805. Light 807 illuminating the display 805 may be reflected towards the first side 803a of the light guide 803 and out of the display device 800 towards a viewer. To maximize the brightness and efficiency of the display 805, the light turning features 820 can be configured to reflect light at an angle normal to the display or close thereto. Light 807 that does not at first reflect off of the turning features 820 may continue to propagate through the light guide 803 and subsequently reflect off of the turning features 820 toward the reflective display 805.

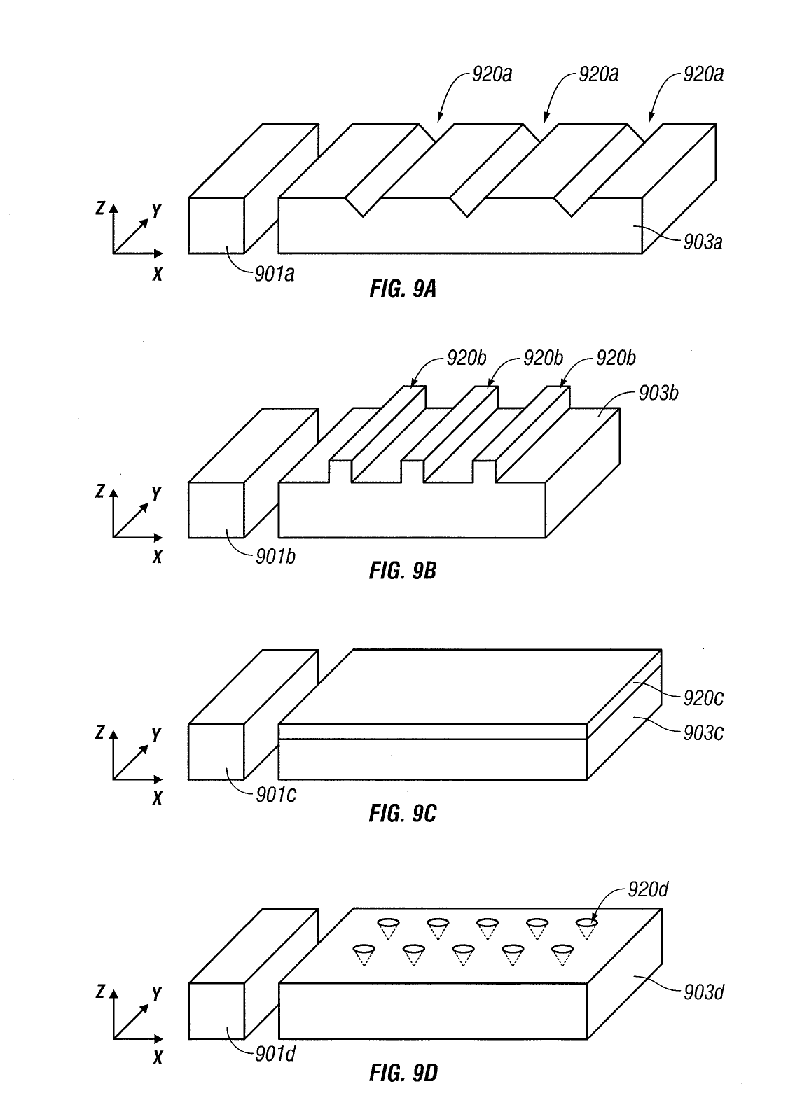

As shown in FIGS. 9A-9D, turning features 920 may comprise reflective, diffractive, and/or light scattering features to turn light toward a reflective display: FIGS. 9A and 9D illustrate embodiments of light guides 903 comprising turning features 920 that have generally polygonal cross-sectional shapes. The turning features 920 in FIGS. 9A and 9D may turn light in one or more directions. FIG. 9B illustrates an embodiment of a light guide 903 comprising surface diffractive turning features 920b configured to turn beams of light toward one or more directions (e.g., toward a reflective display). FIG. 9C illustrates an embodiment of a turning feature 920c that comprises a volume diffractive turning film to turn light toward one or more directions. Different types of light turning features (e.g., reflective, diffractive, or light scattering) may be used on a light guide.

Turning features 920 can vary in size and shape. FIGS. 9A-9D illustrate embodiments where each turning feature 920 on a light guide 903 can be substantially the same size and shape. In other embodiments, the turning features 920 on a light guide 903 may vary in size and/or shape. In some embodiments, a light guide 903 comprises a plurality of turning features 920 that may have different cross-sectional shapes, or include a plurality of turning features 920 each having a generally similar cross-sectional shape. In some embodiments, a light guide 903 comprises a first group of turning features 920 each having a generally similar cross-sectional shape and a second group of turning features 920 each having a generally similar cross-sectional shape wherein the first group of features 920 are generally differently shaped than the second group of turning features. Turning features can be configured to have generally polygonal cross-sectional shapes, for example, square, rectangular, trapezoidal, triangular, hexagonal, octagonal, or some other polygonal shape (for example, turning features 920 shown in FIGS. 9A and 9D having a generally triangular cross sectional shape, and in FIG. 9B a generally rectangular cross-sectional shape). In other embodiments, turning features 920 have a generally curvilinear cross-sectional shape, or a generally irregular cross-sectional shape. The cross-sectional shape of a turning feature 920 may be symmetric or asymmetric.

In some embodiments, the shape formed by the surface of a turning feature may resemble a cone, a frustum of a cone (e.g., a truncated cone), a pyramid, a frustum of a pyramid (e.g., a truncated pyramid), a prism, a polyhedron, or another three-dimensional shape. For example, the shape formed by the turning features 920d shown in FIG. 9D resembles a cone. The shape of the turning features 920d viewed from the top may be polygonal, curvilinear, irregular, generally polygonal, generally curvilinear, square, triangular, rectangular, circular, round, or another shape.

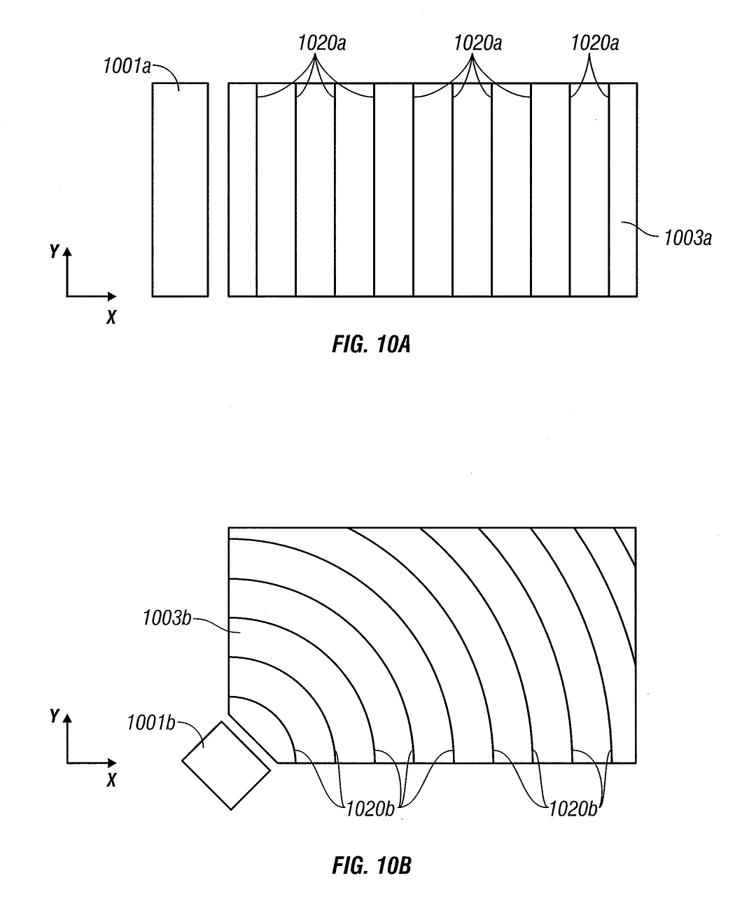

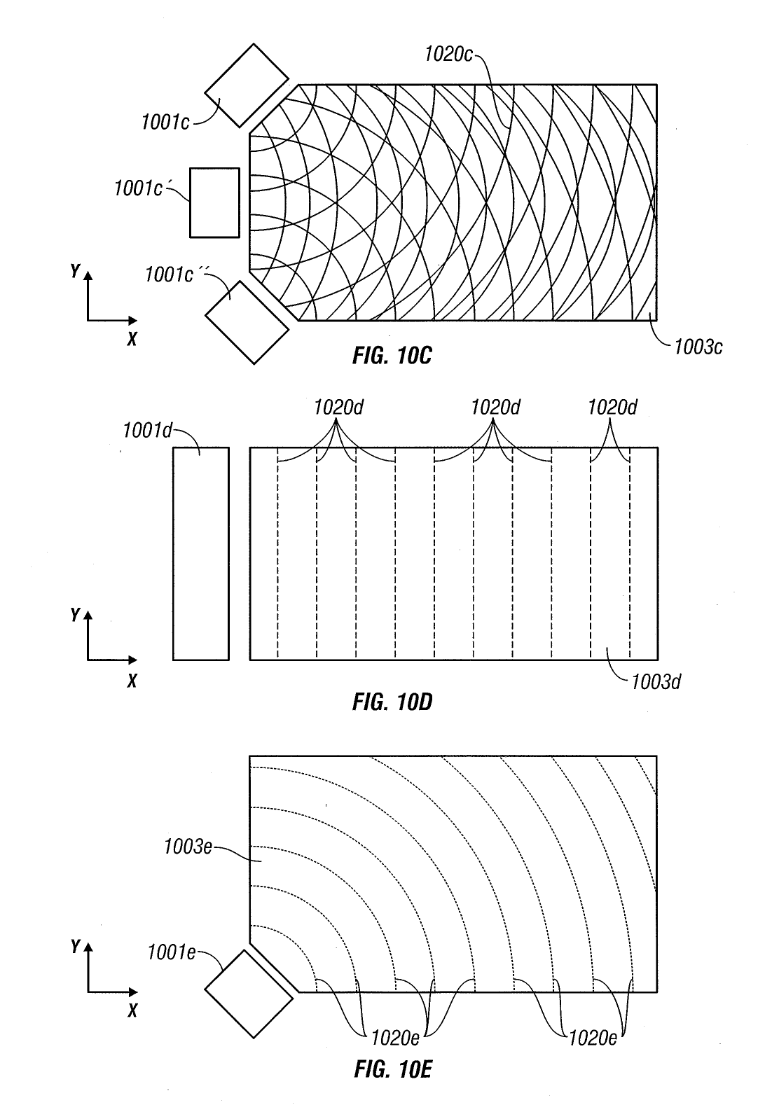

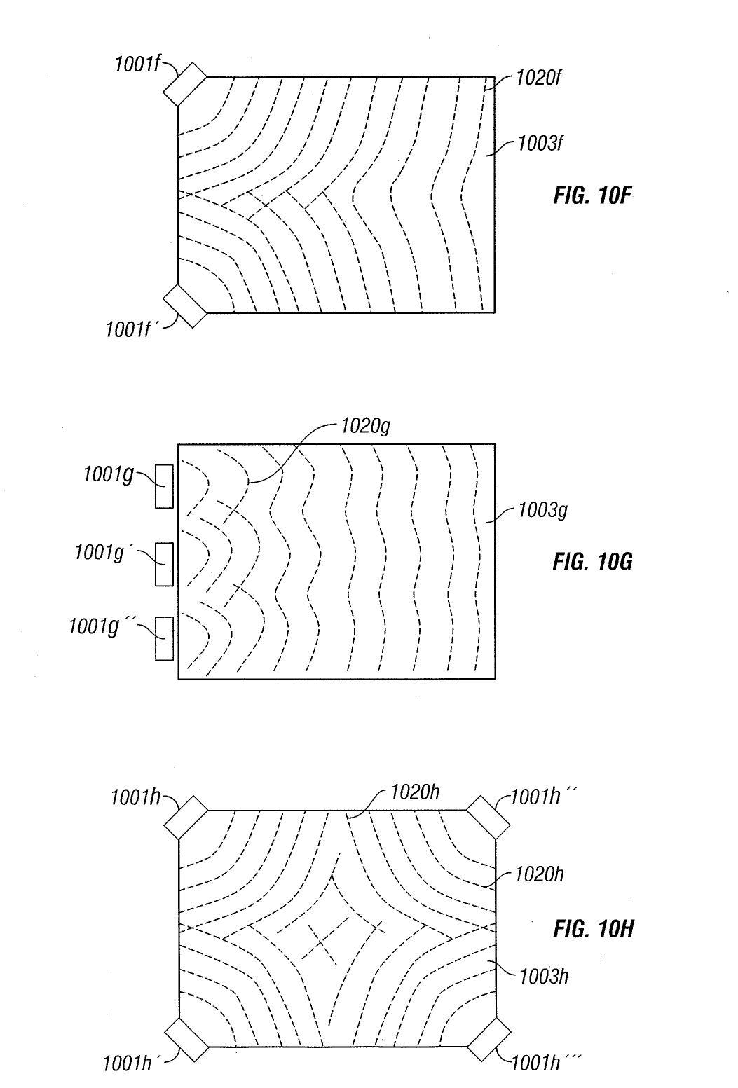

In some embodiments, the turning features may comprise grooves that run in one or more lines across a light guide. The grooves can be continuous or configured as a series of smaller grooves or line segments arranged within a line. In some embodiments, the grooves comprise individual segments of turning features that extend in directions generally normal to the light source(s). For example, FIG. 10A illustrates an embodiment of a light guide 1003a having turning features 1020a that comprise parallel continuous grooves running vertically (e.g., in the y-direction) across the light guide. In another example, FIG. 10B illustrates an embodiment of a light guide 1003b having turning features 1020b that comprise continuous grooves that run in curvilinear trajectories disposed radially from a single point. In another example, FIG. 10C, illustrates an embodiment of a light guide 1003c having turning features 1020c that comprise grooves that run in various curvilinear trajectories disposed radially from three different points. In some embodiments, a plurality of turning features may be aligned along one or more lines across a light guide. For example, in FIG. 10D a plurality of light turning features 1020d are aligned in vertical lines on the light guide 1003d. FIGS. 10E-10H illustrate embodiments of light guides 1003 where a plurality of turning features 1020 are aligned along a plurality of curves. In some embodiments, the shapes or trajectories of the curves formed by the plurality of turning features 820 can depend in part on the location of the light source(s). For example, FIG. 1011 illustrates an embodiment of a light guide 1003h disposed near four light sources 1001h-1001h′″. As illustrated in FIG. 10H, the light guide 1003h may include one or more curve-shaped structures, or a series of one structures aligned in one or more curves, formed by light turning features 1020h and that are disposed radially from the four light sources 1001h-1001h′″. Such curved structures can also comprise one or more redirection features aligned to form such curve-shaped structures or included in addition to the curve-shaped structures.

The quantity and pattern of turning features can vary in different embodiments. For example, the quantity and pattern of turning features 920a in the embodiment illustrated in FIG. 9A varies from the quantity and pattern of turning features 920d in the embodiment illustrated in FIG. 9D. The quantity and pattern of turning features can affect the total efficiency of a display device and/or the uniformity of light extraction across a display device. Additionally, the quantity and pattern of turning features on a light guide may depend upon the size and/or shape of the turning features. In some embodiments, between about 2% and about 10% of the total top surface area of a light guide is configured with turning features. In one embodiment, about 5% of the total top surface area of a light guide is configured with turning features. In some embodiments, turning features are disposed about 100 microns from one another on a light guide, for example, on the top surface of a light guide.

In FIGS. 9A, 9B, and 10A-10E, the turning features 920, 1020 in the light guides 903, 1003 are periodic. In FIGS. 9A, 9B, 10A, and 10D, the turning features 920, 1020 are generally parallel to each other as shown and are periodic in the x-direction. In some embodiments, the turning features are semi-periodic or aperiodic. The light turning features 920, 1020 in FIGS. 9A, 9B, 10A, and 10D extend in the vertical direction (y-direction). In some embodiments, the light turning features may be periodic and extend in the horizontal direction (x-direction) or a direction in between the horizontal direction and the vertical direction.

A light source configured to provide light into a light guide can be positioned in various locations relative to the light guide, depending on the configuration of the illumination device. In some embodiments, the light guide is generally planar having four sides and a top and bottom surface. FIGS. 9A-10A and 10D illustrate embodiments of generally planar light guides 903, 1003 with light sources 901, 1001 disposed adjacent to one of the four sides of the light guide. In other embodiments, the light guide can have more than four sides. FIGS. 10B and 10E illustrate embodiments of generally planar light guides 1003 that have five sides and a light source 1001 disposed adjacent to one of the five sides. In other embodiments, a light guide may have more than five sides and a top and bottom surface. For example, FIG. 10C illustrates an embodiment of a light guide 1003c that is generally planar and has 6 sides and a top and bottom surface. Three different light sources 1003c, 1003c′, and 1003c″ are disposed adjacent to three different sides. In some embodiments, the spatial distribution, size, shape, quantity, type, and/or pattern of light turning features is chosen based on the type, quantity, and/or location of the light source(s).

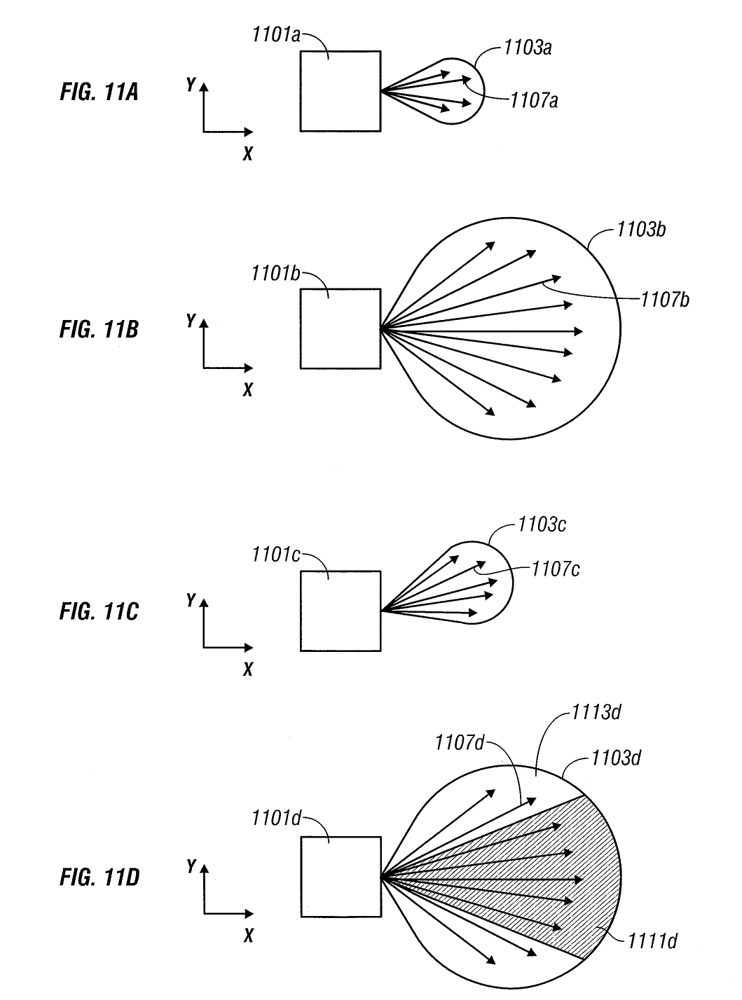

FIGS. 11A-11E illustrate different embodiments of top plan views of light sources 1101 emitting light in varying directions to form a certain light pattern 1103, which is sometimes referred to herein as a “lobe” of light or “light lobe.” Each lobe 1103 comprises a plurality of light beams 1107 directed in different directions along a plane that is parallel to the x-y plane. The direction and size of the light lobes 1103 can vary from light source 1101 to light source 1101 and may also be affected by characteristics of the input surface/edge of the light guide which receives light from the light source. In other words, a light guide with a rough input edge or surface may affect the shape and/or direction of a lobe of light 1103 input into the light guide. For example, the lobe of light 1103b illustrated in FIG. 11B is larger than the lobes of light 1103 illustrated in FIGS. 11C and 11A. In some embodiments, a light lobe 1103 emitted from a light source 1101 may be centered on a line that is substantially parallel to the x-axis. For example, the light lobes 1103 in FIGS. 11A, 11B, and 11D are centered along a line that is substantially parallel to the x-axis. In other embodiments, lobes of light 1103 may be asymmetric and/or not centered alone a line that is substantially parallel to the x-axis. For example, FIGS. 11C and 11E illustrate embodiments of lobes of light 1103 that are not centered along a line that is substantially parallel to the x-axis.

In some embodiments, lobes of light 1103 may include light beams 1107 outside an angular range of light beams that may be turned by turning features in a light guide. For example, a lobe of light 1103 may be broad and include light beams 1107 in a large angular range (e.g., greater than about 45°). Or a lobe of light 1103 may be centered on a line that is not substantially parallel to the x-axis and a group of light beams 1107 included in the lobe may be directed at an angle relative to the x-axis that is outside of angular range that may be turned by turning features in a light guide. FIG. 11D illustrates an embodiment of a lobe of light 1103d including a group 1111d of light beams 1107d that may be turned by a group of light turning features and a group 1113d of light beams 1107d that may not be turned by the group of light turning features. FIG. 11E illustrates another embodiment of a lobe of light 1103e including a group 1111e of light beams 1107e that may be turned by a group of light turning features on a light guide, and a group 1113e of light beams 1107e that may not be turned by the group of light turning features. The group 1113e of light beams 1107e that is outside an angular range of light that may be turned by light turning features can be referred to as “lost” light because it is not subsequently turned toward a reflective display and reflected toward a viewer. The angular range of light that may be turned by light turning features depends in part on the size, shape, type, pattern, quantity, and location of light turning features on a light guide as well as on the size and shape of the light guide. Thus, the angular range of light that may be turned by light turning features can vary.

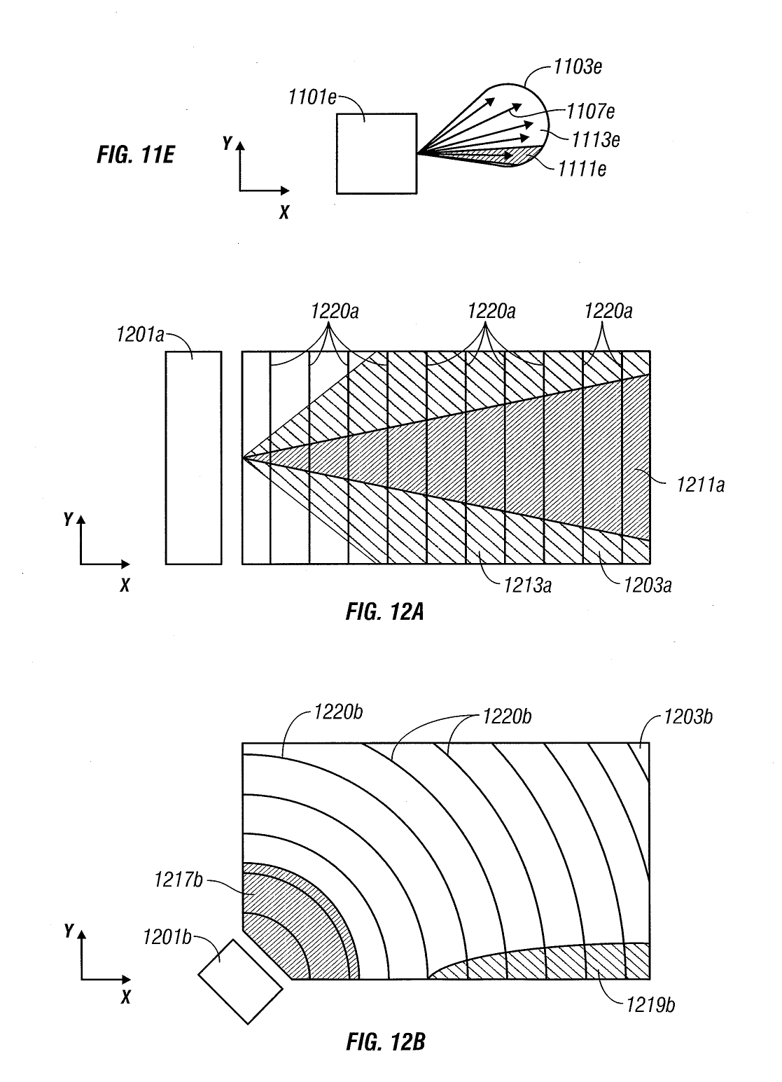

FIGS. 12A and 12B illustrate top plan views of embodiments of light guides 1203 where light extraction is not uniform across the top surfaces of the light guides due to the incident angle of the light on the turning features. FIG. 12A illustrates an embodiment where a light source 1201a is disposed adjacent to one of four sides of a rectangular light guide 1203a. The light source 1201a emits a lobe of light including a group 1211a of light beams that are within an angular range of light that may be turned by light turning features 1220a, and a group 1213a of light beams that are outside of the angular range of light that may be turned by light turning features 1220a. The group 1213a of light beams may be considered lost light because it is not turned towards a reflective display and/or is turned towards a reflective display at non-useful angles and subsequently reflected toward a viewer. The lost light 1213b may cause dark portions (or “cold” portions) in the light guide 1203a and results in non-uniform light extraction across the device.

FIG. 12B illustrates an embodiment of a light guide 1203b that includes five sides with a light source 1201b disposed adjacent to one of the five sides. Light emitted from the light source 1201b is received by the light guide 1203b and turned in certain portions toward a reflective display. In some embodiments, the lobe of light (not shown) emitted by the light source 1201b may not include light beams directed towards all portions of the light guide 1203b and the light extraction across the light guide 1203b may not be uniform as a result. In some embodiments, more light may be extracted in a first portion 1217b than across other portions of the light guide 1203b. In some embodiments, a second portion 1219b of the light guide 1203b may appear relatively dark because little light is turned by light turning features 1220b toward the reflective display in this second portion 1219b. The uniformity of light extraction across a light guide can be addressed by varying the quantity, pattern, size, shape, and/or location of light extraction features. However, in some embodiments, lost light emitted may still result in diminished display device efficiency even if light is extracted across a device uniformly.

FIG. 12C illustrates a light guide 1203c comprising groups 1220c of obliquely oriented turning features 1220c′. The orientation of a turning feature 1220c′ can be different from the orientation of the group 1220c that the turning feature is a part of. In some embodiments, the individual turning features 1220c′ are oriented vertically or in a direction parallel to the first edge 1204c of the light guide 1203c. The length of each turning feature 1220c′ is small compared to the length of the group 1220c or to the length of the first end 1204c of the light guide 1203c. In some embodiments, the length of each turning feature 1220c′ is similar and/or less than to the resolution of a human eye. The length of each turning feature 1220c′ may be small enough such that the individual features 1220c′ are not visible to a human, and that the group 1220c of features looks like a continuous line. In one instance, the length of one, more than one, or all of the turning features 1220c′ is such that individual turning features 1220c′ are indistinguishable by an unaided human eye. An unaided human is one without the aid of an optical system with optical power, for example, a magnifier or microscope. For example, a human may be unable to determine that a plurality of distinct turning features 1220c′ are present or may not be able to distinguish a single turning feature from adjacent turning features. The groups 1220c of turning features 1220c′ may have a length (in a direction parallel to the first side 1204c of the light guide 1203c) that is less than 5%, 4%, 3%, 2%, 1%, 0.5%, 0.3%, 0.2%, 0.1%, 0.05%, or 0.01% of a width of the light guide 1203. The turning features 1220c′ may have two ends that do not contact other turning features and/or ends and/or edges of the light guide 1203c. In some embodiments, features 1220c′ are arranged in rows. In some embodiments, the light guide 1203c is configured with redirection features (for example, cone or frustum-shaped re-direction features) disposed amongst, or in place of, some or all of the turning features 1220c′.

Each turning feature 1220c′ may comprise an exposed portion. The exposed portion is the portion of the feature 1220c′ which could turn light from the light guide incident upon the feature at an about normal angle. In the example shown in FIG. 12C, the exposed portion of each 1220c′ is the length of the element 1220c′. However, if all turning features 1220c′ were substantially longer in the downward direction, the bottom portions of the turning features 1220c′ may be unexposed, as adjacent features 1220c′ may obstruct the bottom portions. In some embodiments, centers of the exposed portion of a group of turning features are arranged in a line or may be substantially linear. The line may be a diagonal line and/or non-normal and/or non-parallel with respect to the length of the light guide 1203c. In some embodiments, centers of the exposed portions of sides of turning features are arranged in a line or may be substantially linear. Accordingly, a side of the features 1220c′, for example, as an exposed side, may be arranged along the line. The turning features 1220c′ form a plurality of groups 1220c that may be arranged along a plurality of parallel lines. At least about 10 lines (and 10 groups 1220c) may be included. Additionally, at least about 10 turning features 1220c′ may be included in each group 1220c. In some embodiments, the diagonal groups 1220c are more parallel to the width of the light guide than the length of the light guide (although being non-parallel to the width). In various embodiments, for example, the diagonal groups 1220c are oriented at an angle of greater than about 45°, 50°, 60°, 70°, 80°, or 90° with respect to the length of the light guide.

Light propagates from the first end 1204c to the second end 1204c′ of the light guide 1203c at substantially normal incidence to the vertical orientation of the features 1220c′. This arrangement reduces the edge shadow effect as light is directed at substantially normal incidence to the vertical orientation of the features 1220c′ even in the corners at substantially normal incidence. However, although light extraction across the light guide 1203c may be substantially uniform, light emitted from a light source at angles that may not be turned by the features 1220c′ may be lost and decrease the overall illumination efficiency of the display.

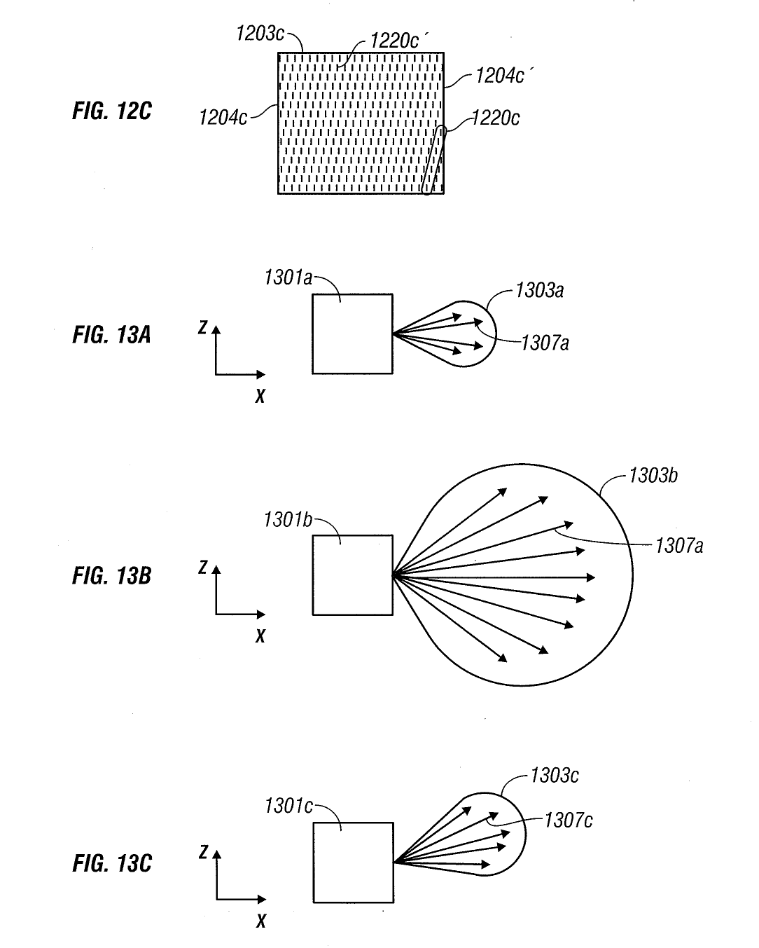

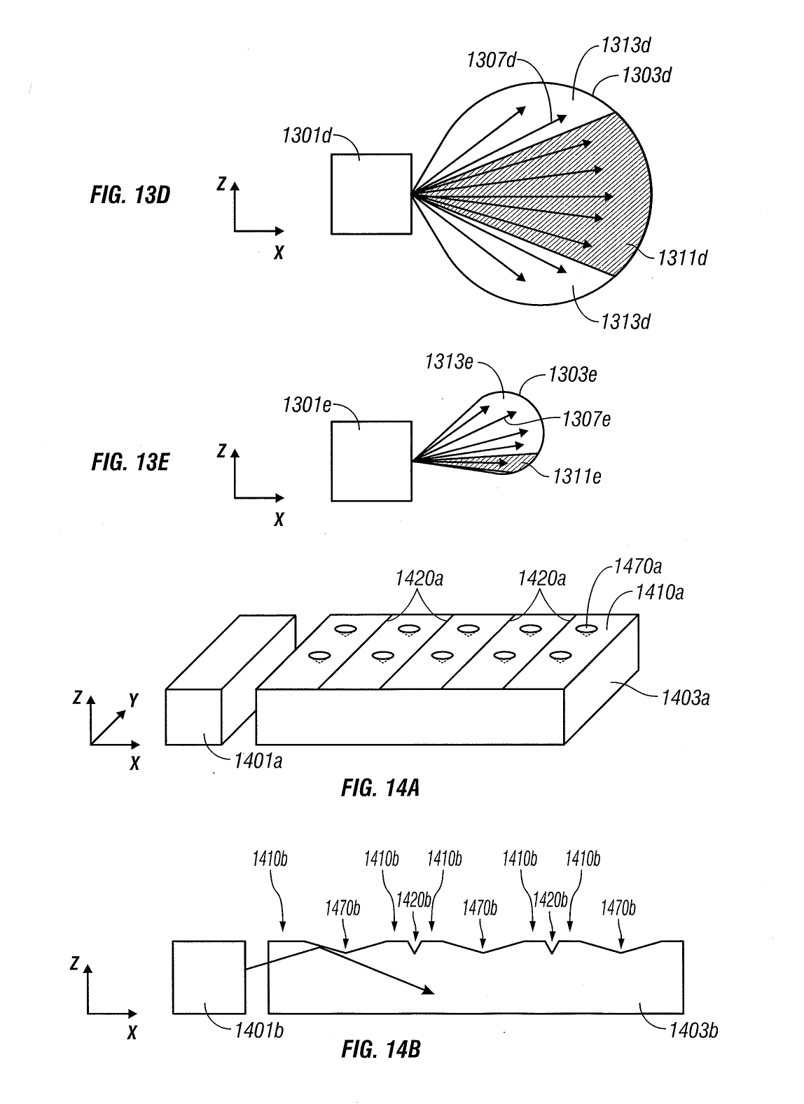

FIGS. 13A-13E illustrate different embodiments of side views of light sources 1301 emitting lobes of light 1303 in various directions. Each lobe of light 1303 comprises a plurality of light beams 1307 headed in different directions along a plane parallel to the x-z plane. The breadth and direction of each lobe 1303 can vary depending on the light source and/or on characteristics of the light guide (not shown) that the lobe 1303 is input in. In some embodiments, a lobe 1303 may be centered on a line or axis that is substantially parallel to the x-axis. In other embodiments, a lobe 1303 may be centered along a line or axis that is not substantially parallel to the x-axis. In some embodiments, a light source 1301 may emit more than one lobe 1303 of light. As shown in FIGS. 13D and 13E, in some embodiments, lobes of light 1303 may include light beams 1307 that are outside an angular range of light beams that may be turned by turning features in a light guide. For example, FIGS. 13D and 13E illustrate lobes of light 1303 that include a first group 1311 of light beams 1307 that is within an angular range of light that may be turned by light turning features (not shown). Additionally, FIGS. 13D and 13E illustrate second groups 1313 of light beams 1307 that are outside an angular range of light that may be turned by light turning features and thus, the second groups 1313 may be considered lost light because they are not reflected off of a reflective display towards a viewer.

Certain embodiments of light guides disclosed herein comprise light redirection features with light turning features to increase the efficiency of display devices while generally extracting light uniformly across the light guides. Light redirection features may redirect light propagating within a light guide that cannot be turned by light turning features in a new direction such that the light can be turned by light turning features. In other words, light redirection features may be configured to change the direction of a given light beam such that the beam is still guided within the light guide but propagates in a more useful direction (e.g., a direction that may be turned by light turning features). Embodiments of light redirection features disclosed herein can redirect light “in-plane” (e.g., along a plane that is substantially parallel to the x-y plane of the light guide), “out-of-plane” (e.g., along a plane that is substantially parallel to the x-z plane of the light guide), or both in-plane and out-of-plane.

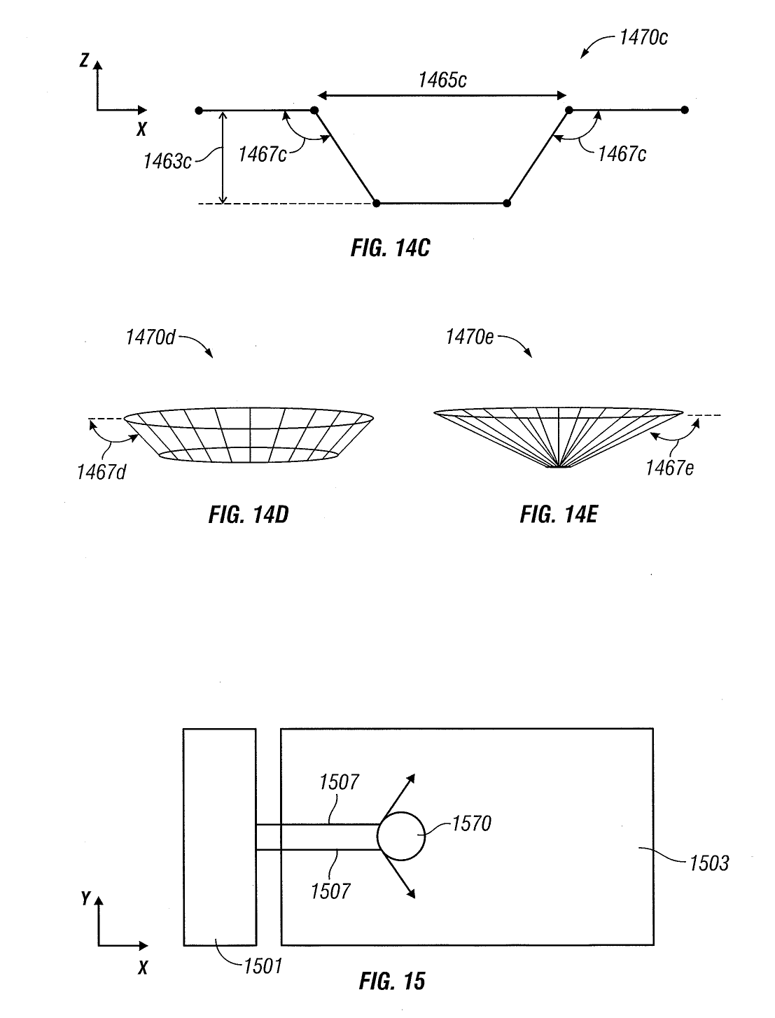

FIGS. 14A-14B illustrate embodiments of light guides 1403 that can have light turning features 1420 and light redirection features 1470. As discussed above, the size, shape, type, pattern, and quantity of light turning features 1420 can vary. The light redirection features 1470 may similarly vary in size, shape, type, pattern, and quantity. The light redirection features 1470 illustrated in FIGS. 14A and 14B comprise indentations or depressions formed in a top planar surface of the light guide 1403. The indentations can be configured to include light redirection sections (e.g., facets, sidewalls, and/or angled or curved surfaces) configured to receive and turn light propagating within the light guide 1403. The light redirection features 1470 may comprise various three dimensional shapes. For example, the light redirection features 1470 may comprise cones, frustums of cones, pyramids, frustums of pyramids, hemispheres, generally curvilinear shapes, generally polygonal shapes, generally irregular shapes, symmetrical shapes, asymmetrical shapes, prisms, or other shapes. In some embodiments, the light redirection features 1470 may comprise grooves, pits, surface diffractive features, volume diffractive features, holograms, or other structures.

The depth and width of the light redirection features 1470 can vary. In some embodiments, the light redirection features 1470 may comprise shallow cones with relatively low apex angles. In some embodiments, the light redirection features 1470 comprise shallow frustums of cones. In some embodiments, the light features 1470 on a light guide 1403 vary from one another in size and/or shape. For example, a light guide 1403 may include a first group of light redirection features 1470 having a first shape and a second group of light redirection features having a second shape wherein the first shape is generally different from the second shape. As illustrated in FIG. 14B, the light redirection features 1470b may vary in size and/or shape from the light turning features 1420b.

FIGS. 14C-14E illustrate additional embodiments of light redirection features 1470 which are rotationally symmetrical. The light redirection features 1470 can be formed in a light guide or in a turning film that is disposed over a light guide. As illustrated, in some embodiments light redirection features may be generally cone-shaped and have an apex. In other embodiments, the light redirection features can be generally frustum-shaped, for example, frusto-conical. FIG. 14C illustrates an embodiment of a frustum-shaped turning feature 1470c. The turning feature 1470c includes a maximum width dimension 1465c and a depth dimension 1463c. The width dimension 1465c and depth dimension 1463c can be selected to create an obtuse angle 1467c formed between a plane that is level with the top of the turning feature 1470c and a turning section of the turning feature. In some embodiments, the depth 1463c can be about 0.5 to about 5.0 microns, and the angle 1467c can be about 170 degrees to 179.5 degrees.

The angle 1467c can be selected to redirect light within a light guide that the turning feature is formed in. In some embodiments, the angle 1467c can be between about 130° and about 180°. For example, the angle 1467c can be about 130°, 131°, 132°, 133°, 134°, 135°, 136°, 137°, 138°, 139°, 140°, 141°, 142°, 143°, 144°, 145°, 146°, 147°, 148°, 149°, 150°, 151°, 152°, 153°, 154°, 155°, 156°, 157°, 158°, 159°, 160°, 161°, 162°, 163°, 164°, 165°, 166°, 167°, 168°, 169°, 170°, 171°, 172°, 173°, 174°, 175°, 176°, 177°, 178°, 179°, 180°, and/or any value between and including any two of these angles. In one embodiment, a generally conical turning feature has a maximum width dimension 1465c of about 10 micron, a depth dimension of about 0.5 micron, and an obtuse angle formed between a plane that is level with the top of the turning feature and a sidewall of the turning feature of about 84 degrees. Other alternative configurations are also possible, including for example, components (e.g., layers) may be added, removed, and/or rearranged.

In some embodiments, the light redirection features 1470 may be configured to redirect light incident thereon in a new direction on a plane generally parallel to the x-z plane (e.g., out-of-plane). FIG. 14B illustrates a side view of an embodiment of a light guide 1403b comprising turning features 1420b and light redirection features 1470b. As illustrated, the light redirection features 1470b may redirect light 1407b incident thereon in a new direction on a plane generally parallel to the x-z plane. In some embodiments, the light redirection features 1470b may be configured to turn light toward a display device and in other embodiments, the light redirection features may be configured to redirect light incident thereon at shallow angles within the light guide 1403b.

FIG. 15 illustrates a top view of an embodiment of a light guide 1503 comprising a redirection feature 1570. The light redirection feature 1570 is configured to redirect light 1507 incident thereon in a new direction on a plane generally parallel to the x-y plane (e.g., in-plane). In some embodiments, the light redirection feature 1570 illustrated in FIG. 15 may comprise a cone similar to the turning features 1470 illustrates in FIGS. 14A and 14B. In other embodiments, the light redirection feature 1570 may comprise a frustum of a cone. Such light turning features 1570 may be configured to redirect light incident thereon in-plane and/or out-of-plane.

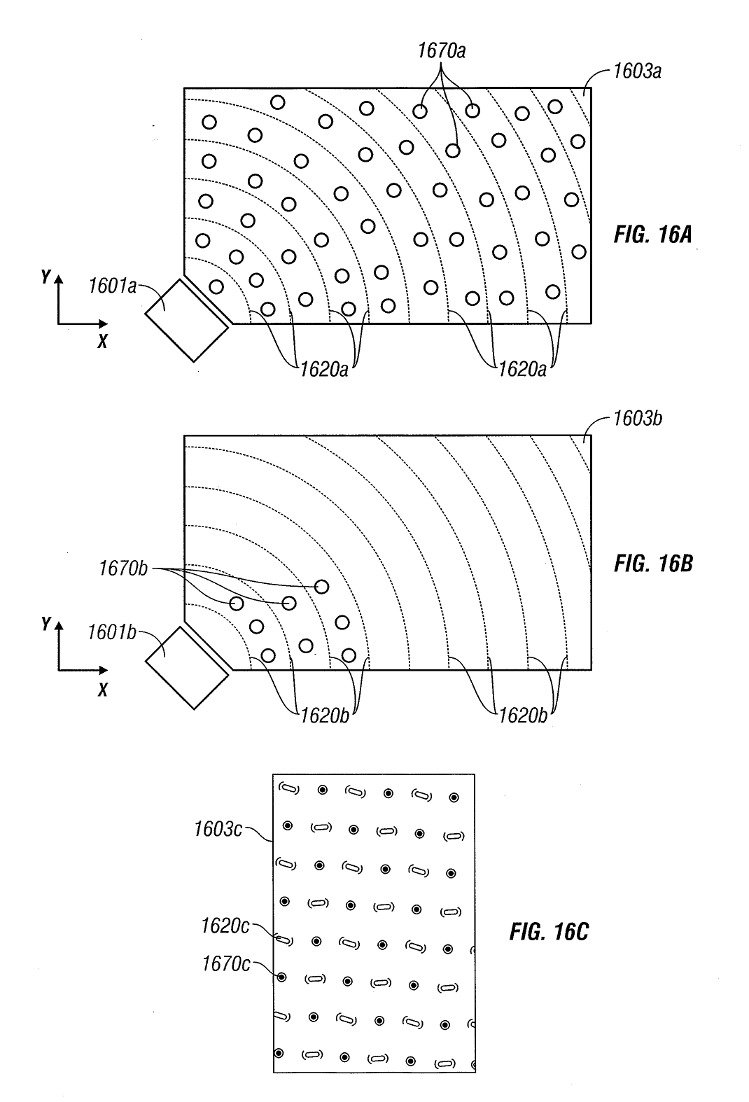

The pattern and quantity of light redirection features can vary, depending on a desired implementation and optical characteristics. FIG. 16A illustrates an embodiment of a light guide 1603a where light redirection features 1670a are disposed generally uniformly across the light guide. The pattern and quantity of light redirection features 1670a may depend in part on the size and shape of the light turning features 1620a as well as on the light distribution characteristics of the light source(s) 1601a. In some embodiments, light redirection features 1670 may be disposed in a pattern to increase the uniformity of light extraction across the light guide 1603a. For example, in one embodiment, light redirection features 1670a are disposed near a light source 1601a in order to redirect light to other portions of the light guide 1603a (e.g., to dark corners). In some embodiments, a plurality of light turning features 1620a may be disposed in a curve with each light turning feature 1620a extending in a direction generally normal to the light source(s). In some embodiments, a plurality of line segment shaped turning features 1620a are disposed in a curved path with light redirection features 1670a comprising cones or frustums of cones interspersed throughout. FIG. 16B illustrates an example embodiment of a light guide 1603b where light redirection features 1670b are disposed near the light source 1601b and are not disposed on other portions of the light guide 1603b. FIG. 16C illustrates an embodiment of a light guide 1603c having light redirection features 1670c disposed amongst light turning features 1620c. The light redirection features 1670c may comprise indentations or depressions in the light guide 1603c, for example, cones or frustums of cones. In some embodiments, the light redirection features 1670c and light turning features 1620c may be similarly shaped. In some embodiments, the light turning features 1620c may extend in directions generally normal to a light source (not shown). The pattern of the light redirection features 1670c may be chosen to eliminate dark corners on the light guide 1603c and/or to decrease the occurrence of bright spots. In some embodiments a light bar may be used as a light source 1601c and emits a light output which is asymmetric. In such embodiments, the output of the light bar may be redistributed throughout the light guide 1603c using light redirection features 1601c.

In some embodiments, the light redirection features 1670 may be formed in the light guide 1603 using nano-indentation techniques. In one embodiment, a tool comprising a shaped and hardened tip is impinged into a light guide 1603 comprising a soft deformable plastic in a desired pattern. For example, the tool may be impinged into a light guide 1603 to create a uniform distribution of indentations with similar shapes and depths. In some embodiments, multiple tools with varying tips can be used to vary the size and/or shape of the depressions. After the desired quantity and pattern of depressions are made in the soft plastic, the light guide 1603 may be replicated using electroforming into a hard tool to use as a guide to fabricate subsequent light guides 1603. In some embodiments, turning features 1620 may also be formed in the soft plastic light guide 1603 using known techniques, for example, diamond turning, to create a hard tool comprising light redirection features 1670 and light turning features 1620. Light redirection features 1670 may also be formed using various photolithographic techniques known to those of skill in the art.

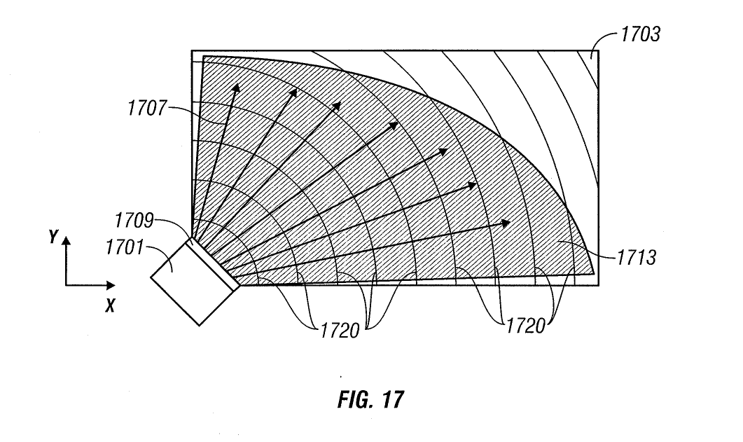

In some embodiments, the problem of lost light emitted from a light source may be addressed by disposing a diffractive layer between the light source and the light guide. FIG. 17 illustrates an example embodiment where a diffractive layer 1709 is disposed between the light source 1701 and the input edge of the light guide 1703. The diffractive layer 1709 may be configured to diffuse light emitted from the light source 1701 and input the diffused light into the light guide 1703 such that light beams 1707 are directed throughout the light guide 1703. In some embodiments, a diffractive layer 1709 may redistribute the light output of the light source 1701 to create an angular distribution of light beams 1707 that may be turned by turning features 1720. In some embodiments, a display device may comprise a diffractive layer 1709 and light redirection features, for example, the light redirection features 1470, 1570, 1670 illustrated in FIG. 14A-16B.

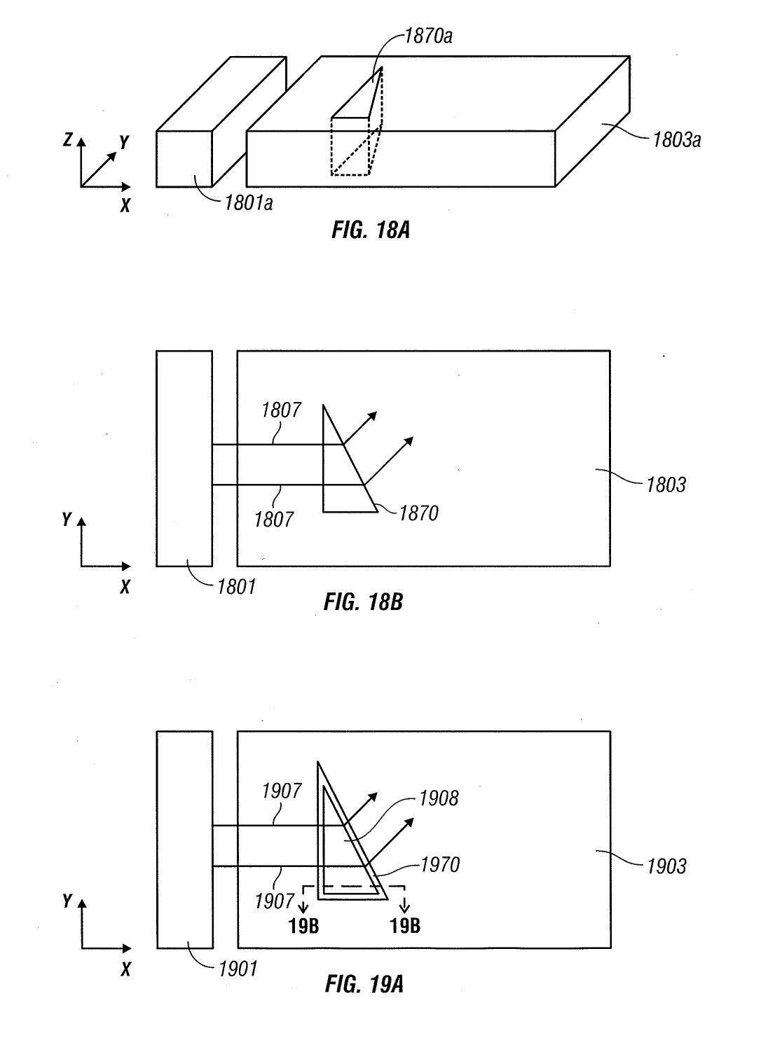

FIGS. 18A-22 illustrate embodiments of turning features that use refraction to redistribute light in-plane (e.g., on a plane parallel to the x-y axis). FIG. 18A illustrates a perspective view of a light guide 1803 and a light redirection feature 1870 embedded within the light guide. The light redirection feature 1870 may comprise any structure formed of material with a different index of refraction than the light guide 1803, including for example, air. Light redirection features 1870 may be formed in the light guide using a variety of processes, for example, anisotropic reactive ion etching or other photolithographic processes. The size, shape, quantity, and/or pattern of light redirection features 1870 can vary from light guide 1803 to light guide or within a light guide.

FIG. 18B illustrates a top view of the light guide 1803 of FIG. 18A. Light beams 1807 emitted from the light source 1801 may impinge the light redirection feature 1870 at near normal incident or close thereto. In some embodiments, the light beams 1807 may then break TIR and propagate through the light redirection feature 1870 until exiting the light redirection feature 1870 and re-entering the light guide 1803. Because the light redirection feature 1870 comprises a material with a different index of refraction than the rest of the light guide 1803, the direction of the light beams 1807 changes when the beams cross the boundary between the light redirection feature 1870 and the light guide 1803. The degree of refraction at the boundary between the light redirection feature 1870 and the light guide 1803 can be calculated by Snell's Law.

The light redirection features 1870 can comprise various three dimensional shapes, for example, prisms, generally triangular prisms, right triangle prisms, boxes, cubes, cylinders, half-cylinders, wedges, spheres, hemispheres, symmetrical shapes, asymmetrical shapes, generally curvilinear shapes, generally polygonal shapes, or irregular shapes. The light redirection feature 1870 illustrated in FIGS. 18A and 18B comprises a right triangle prism. In some embodiments, the size of a turning feature 1870 may affect the contrast of the display to a viewer by refracting light reflected from a reflective display. Accordingly, in certain embodiments it may be preferable to limit the area of refractive features 1870 as viewed from the top of a light guide 1803.

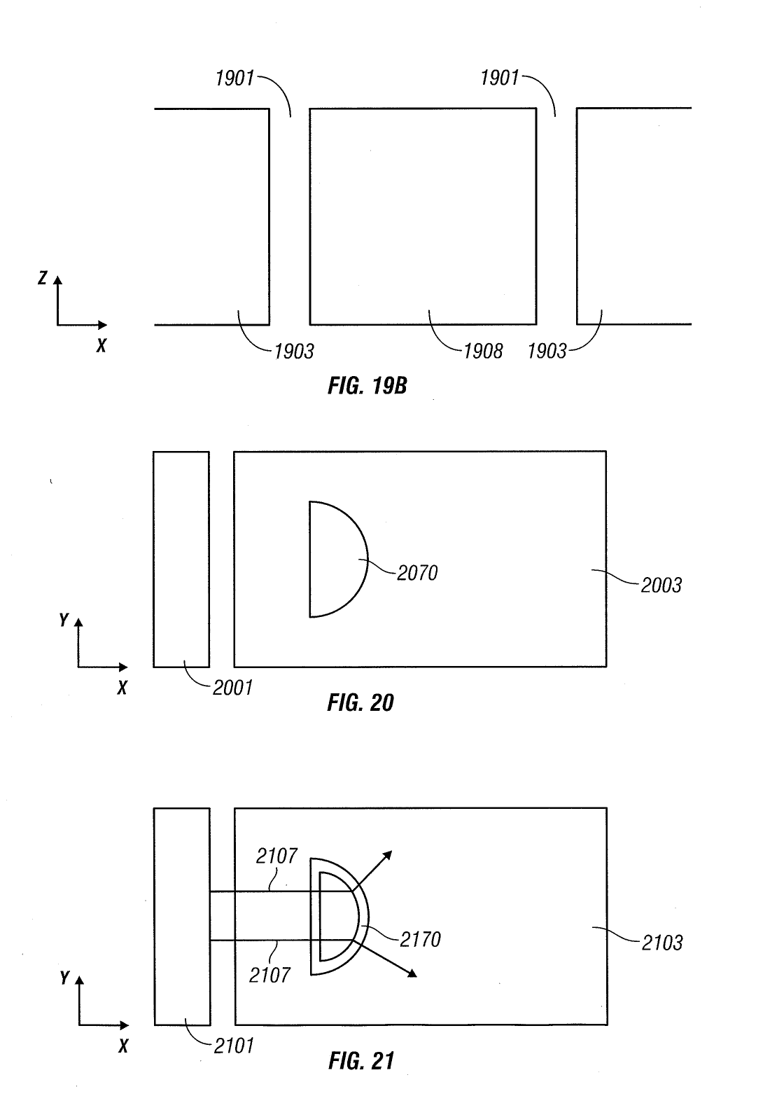

FIGS. 19A and 19B illustrate an embodiment where the light redirection feature 1970 comprises a shell of a right triangle prism. As shown in FIG. 19B, the refractive light redirection feature 1970 includes an outer boundary material layer 1901 and an inner material layer 1908. The inner material layer 1908 may comprise a material with an index of refraction that is substantially the same as the index of refraction of the light guide 1903. In some embodiments, the inner material layer 1908 may comprise the same material as the light guide 1903. The outer boundary material layer 1901 may comprise any material with a different index of refraction than the light guide 1903 and inner material layer 1908, for example, air. In embodiments of refractive redirection features 1970 that comprise shells of three-dimensional shapes, light beams propagating therethrough are refracted and the surface area of the feature 1970 viewed from the top can be minimized by matching the index of refraction of the inner material layer 1908 with the rest of the light guide 1903.

FIGS. 20 and 21 illustrate additional embodiments of refractive light redirection features 2070, 2170 comprising curvilinear three-dimensional shapes. Light redirection features 2070, 2170 can vary in size and/or shape from one light guide 2003, 2103 to another or within a given light guide. In some embodiments, a light guide 2003, 2103 may comprise a first group of light redirection features 2070, 2170 having a first shape and a second group of light redirection features having a second shape wherein the first shape is generally different from the second shape. Similarly, in some embodiments, a light guide 2003, 2103 may comprise a first group of light redirection features 2070, 2170 having a first size and a second group of light redirection features having a second size wherein the first size is generally different from the second size. In some embodiments, light redirection features 2070, 2170 on a light guide 2003, 2103 may vary from one another in one of size or shape.

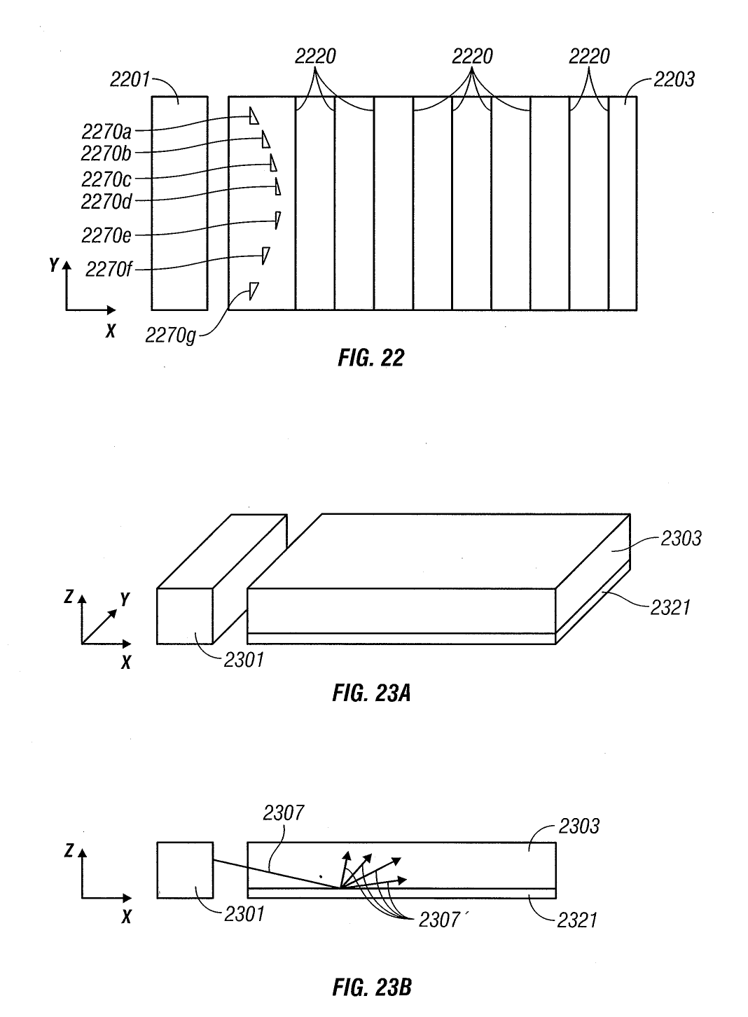

FIG. 22 illustrates an embodiment of a light guide 2203 comprising multiple refractive light redirection features 2270a-2270g. Light redirection features 2270a-2270g may vary in shape and/or size in order to redistribute light emitted from the light source 2201 throughout the light guide 2203. In the illustrated embodiment, each light redirection feature 2270a-2270g comprises a right triangle prism. The angle formed between the hypotenuse and side of the right triangle generally parallel to the light source 2201 in the light redirection features 2270 increases from redirection feature 2270a to redirection feature 2270d. Additionally, redirection features 2270e-2270g may mirror redirection features 2270a-2270d. Different patterns, sizes, quantities, and shapes of redirection features 2270 may be formed on a light guide 2203 to redistribute or redirect light in-plane. In some embodiments, light redirection features 2270 may comprise three dimensional shapes configured to redirect light out-of-plane and/or in-plane. In some embodiments, a light guide 2203 may comprise a group of light redirection features 2270 that redirect light in-plane and a group of light redirection features 2270 that redirect light out-of-plane.

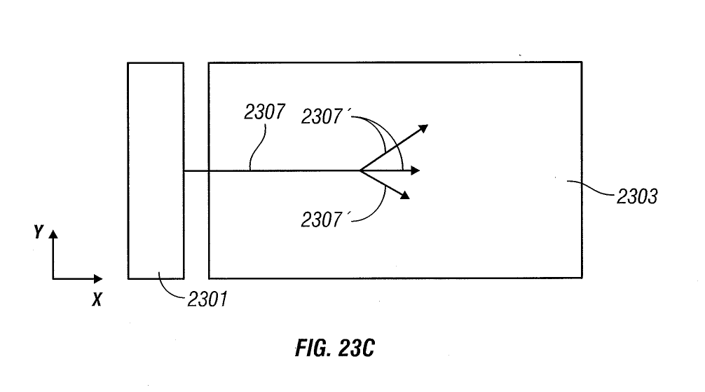

Turning now to FIGS. 23A-23C, an embodiment of a light guide 2303 disposed parallel to a diffractive redirection layer 2321 is illustrated. In some embodiments, a diffractive redirection layer 2321 may redirect light incident thereon in useful directions within the light guide 2303. FIG. 23B illustrates a side view of the embodiment of FIG. 23A where light 2307 incident on the diffractive redirection layer 2321 is redirected within the light guide in light beams 2307′. In some embodiments, a diffractive redirection layer 2321 may comprise a low haze diffuser where haze indicates the diffusion ratio of the diffractive layer 2321. As shown in FIGS. 23B and 23C, a diffractive layer 2321 may redirect light within a light guide in-plane and/or out-of-plane. In some embodiments, the use of a volume diffractive layer 2321 allows adding an angular conversion feature to symmetric light turning features light those produced by wafer-based microfabrication. In some embodiments, the amount of light scattering via a diffractive layer 2321 can match the light extraction per unit length of the light guide 2303. In some embodiments, if more light scattering occurs than extraction, light propagating within the light guide 2303 will eventually break TIR and decrease the display device efficiency. In some embodiments, a light guide 2303 comprises a diffractive layer 2321 in addition to reflective and/or refractive light redirection features, for example, those described above. In some embodiments, a diffractive redirection layer 2321 may be disposed parallel to only a portion of a light guide 2303.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

1. An illumination device comprising:
a light source;
a light guide comprising a first surface, a second surface disposed opposite to the first surface, a first end and a second end, and a length therebetween, the light guide positioned to receive light from the light source into the light guide first end, and the light guide configured such that light from the light source provided into the first end of the light guide propagates towards the second end;
a plurality of light turning features, each light turning feature comprising at least one turning section aligned to turn light propagating toward the second end of the light guide out of the light guide; and
at least one light redirection feature, each light redirection feature comprising at least one redirection section aligned to redirect light incident thereon within the light guide along one or more directions.

2. The device of claim 1, wherein the light guide is disposed with respect to a reflective display such that light turned out of the light guide illuminates the reflective display.

3. The device of claim 2, wherein the reflective display comprises a light modulating array.

4. The device of claim 3, further comprising:
a processor that is configured to communicate with the light modulating array, said processor being configured to process image data; and
a memory device that is configured to communicate with said processor.

5. The device of claim 4, further comprising a driver circuit configured to send at least one signal to the light modulating array.

6. The device of claim 5, further comprising a controller configured to send at least a portion of the image data to said driver circuit.

7. The device of claim 4, further comprising an image source module configured to send the image data to the processor.

8. The device of claim 7, wherein said image source module comprises at least one of a receiver, transceiver, and transmitter.

9. The device of claim 4, further comprising an input device configured to receive input data and to communicate said input data to said processor.

10. The device of claim 1, wherein at least one light turning feature is disposed on the first surface of the light guide and configured to turn light out of the second surface of the light guide.

11. The device of claim 10, wherein at least one light turning feature is disposed on the second surface of the light guide and configured to turn light out of the first surface of the light guide.

12. The device of claim 10, wherein at least one light redirection feature is disposed on the first surface of the light guide.

13. The device of claim 10, wherein at least one light redirection feature is disposed on the second surface of the light guide.

14. The device of claim 1, wherein the turning features comprise elongated grooves.

15. The device of claim 1, wherein the light redirection feature is cone-shaped.

16. The device of claim 15, wherein a redirection section of the cone and the first surface or second surface of the light guide form an obtuse angle that is between about 170 degrees and about 179.5 degrees.

17. The device of claim 1, wherein the light redirection feature is in the shape of a frustum of a cone.

18. The device of claim 17, wherein a redirection section of the frustum of a cone and the first surface or second surface of the light guide form an obtuse angle that is between about 170 degrees and about 179.5 degrees.

19. The device of claim 1, wherein the light redirection feature is in the shape of a pyramid.

20. The device of claim 19, wherein a redirection section of the pyramid and the first surface or second surface of the light guide form an obtuse angle that is between about 170 degrees and about 179.5 degrees.

21. The device of claim 1, wherein the light redirection feature is in the shape of a frustum of a pyramid.

22. The device of claim 21, wherein a redirection section of the frustum of a pyramid and the first surface or second surface of the light guide form an obtuse angle that is between about 170 degrees and about 179.5 degrees.

23. The device of claim 1, wherein the light redirection feature redirects light via reflection.

24. The device of claim 1, wherein the light redirection feature redirects light via refraction.

25. The device of claim 1, wherein the device comprises a plurality of light redirection features.

26. The illumination device of claim 25, wherein the light redirection features are disposed in a uniform pattern throughout the light guide.

27. The illumination device of claim 25, wherein the light redirection features are disposed in a non-uniform pattern through the light guide.

28. The illumination device of claim 25, wherein at least one of the light redirection features varies from at least one other light redirection feature in at least one of size or shape.

29. The illumination device of claim 1, wherein the light redirection features are configured to redirect light in-plane.

30. The illumination device of claim 29, wherein the light redirection features are configured to redirect light on a plane disposed generally parallel to the first surface.

31. The illumination device of claim 1, wherein the light redirection features are configured to redirect light out-of-plane.

32. The illumination device of claim 31, wherein the light redirection features are configured to redirect light on a plane disposed generally normal to the first surface.

33. The illumination device of claim 1, wherein the light redirection features are configured to redirect light out-of-plane and in-plane.

34. The illumination device of claim 1, wherein the light redirection feature is configured to redirect a portion of light incident thereon within the light guide along one or more directions and turn a portion of light incident thereon out of the light guide.

35. An illumination device comprising:
means for providing light;
means for guiding light comprising a first surface, a second surface disposed opposite to the first surface, a first end and a second end, and a length therebetween, the means for guiding light being positioned to receive light from the light source into the means for guiding light first end, and the means for guiding light configured such that light from the means for providing light provided into the first end of the means for guiding light propagates towards the second end;
a plurality of means for turning light configured to turn light propagating toward the second end of the light guiding means out of the means for guiding light; and
a means for redirecting light configured to redirect light incident thereon within the means for guiding light along one or more directions.

36. The device of claim 35 wherein the means for providing light comprises a light emitting diode.

37. The device of claim 35 wherein the means for providing light comprises a light bar.

38. The device of claim 35 wherein the means for guiding light comprises a light guide.

39. The device of claim 35 wherein the means for redirecting light comprises at least one frustum-shaped indentation in the means for turning light.
